(19) United States
(12) Patent Application Publication
(10) Pub. No.: US 2025/0308286 A1
(43) Pub. Date: Oct. 2, 2025

(54) EYE BLINK DETECTION USING AN ULTRASONIC TRANSCEIVER

(71) Applicant: INVENSENSE, INC., San Jose, CA (US)

(72) Inventor: Daniela Hall, Eybens (FR)

(21) Appl. No.: 19/085,735

(22) Filed: Mar. 20, 2025

Related U.S. Application Data
(63) Continuation-in-part of application No. 18/940,502, filed on Nov. 7, 2024.
(60) Provisional application No. 63/597,110, filed on Nov. 8, 2023.
(60) Provisional application No. 63/608,357, filed on Dec. 11, 2023.
(60) Provisional application No. 63/660,901, filed on Jun. 17, 2024.
(60) Provisional application No. 63/703,042, filed on Oct. 3, 2024.

(51) Int. Cl. G06V 40/19; G02B 27/00; G02B 27/01

(52) U.S. Cl. CPC G06V 40/19; G02B 27/0093; G02B 27/0172; G02B 2027/014

(57) ABSTRACT

Devices and methods are provided that facilitate proximity or liveness detection of a user of a wearable device or a user interacting with a device based on ultrasonic information. In various embodiments, machine learning classifier models can be employed to generate classification predictions of a donned or a doffed state of a wearable device. Further embodiments can facilitate eye blink detection and/or classification based on machine learning classifier models of ultrasonic transceiver information, which can facilitate, among other things, user interface control of wearable devices and associated applications and systems.

### PRIORITY CLAIM

This patent application is a continuation in part application that claims priority to U.S. Non-Provisional patent application Ser. No. 18/940,502, filed Nov. 7, 2024, entitled “PROXIMITY AND LIVENESS DETECTION USING AN ULTRASONIC TRANSCEIVER,” which patent application is a Non-Provisional Application that claims priority to U.S. Provisional Patent Application Ser. No. 63/608,357, filed Dec. 11, 2023, entitled “DETECTION OF DONNING/DOFFING OF GOGGLES USING AN ULTRASOUND SENSOR USING MACHINE LEARNING,” and U.S. Provisional Patent Application Ser. No. 63/703,042, filed Oct. 3, 2024, entitled “PROXIMITY AND LIVENESS SENSING,” and which patent application is related to U.S. Provisional Patent Application Ser. No. 63/597,110, filed Nov. 8, 2023, entitled “PROXIMITY AND LIVENESS DETECTION USING AN ULTRASONIC TRANSCEIVER.” Furthermore, this patent application claims priority to U.S. Provisional Patent Application Ser. No. 63/660,901, filed Jun. 17, 2024, entitled “EYE BLINK DETECTION USING ULTRASONIC SENSORS.” The entireties of such U.S. Patent Applications are incorporated by reference herein.

### TECHNICAL FIELD

The subject disclosure relates generally to wearable devices and more specifically to eye blink detection using an ultrasonic transceiver.

### BACKGROUND

Wearable devices (WD) or wearable computing devices comprise a class of devices that are typically battery powered and comprise a central processing unit. They may comprise further features, such as communications, display, and user interface (UI) abilities, input-output (IO), and the like, and they may be provided with an array of sensors to enable feature rich applications. Moreover, wearable devices or wearable computing devices are typical designed to be as small and unobtrusive as possible so as to facilitate comfort and usability without overly hindering a user's activities.

As a result, maintaining battery life is a primary concern, which is at odds with maximizing attractive features and while maintaining small size of wearable devices or wearable computing devices. Thus, ensuring that unnecessary battery drain is kept at a minimum for wearable devices or wearable computing devices is a challenge.

For example, classes of wearable devices or wearable computing devices can include augmented reality (AR) glasses, virtual reality (VR) headsets, or head mounted displays (HMDs). They typically comprise a headset with a display and communications functionality that allows receipt of visual information to be displayed to a user. In addition, to improve user experience, for example, to avoid spoiling a VR experience, such wearable devices or wearable computing devices are both lightweight and battery powered, which places battery life at a premium. Accordingly, it is of paramount importance in such devices that they are powered off or powered down to a low power state when not in use and power on quickly when use is desired.

For instance, VR headsets comprise an optical proximity sensor that shines an infrared (IR) beam and analyzes the reflected infrared energy to determine whether a user is currently using the device. Typically, when a user wears the VR headset, it turns on, using battery power on the order of 10 Watts (W) of power. When the user is not wearing the VR headset, it should remain in a low power state, as governed by the proximity sensor. However, such proximity detection schemes can be thwarted, and resultant power saving opportunities lost, by inanimate obstructions such as the strap of the VR headset or high storage temperatures. As a result, battery capacity can be inadvertently drained during non-use for which the VR headset.

Furthermore, when using wearable computing devices such as augmented reality (AR) glasses, virtual reality (VR) headsets, or head mounted displays (HMDs) and the like, depending on the application, the program employing the wearable computing device can require user interaction, such as asking for an action confirmation, turning on/off wearable computing device, starting or stopping and application such as a game, navigating menus, and so on. Conventionally, users of such wearable computing devices are required to either press a button on the headset or on an external remote, manipulate a mouse, keyboard, or other input device such as a touchpad, and/or issue commands by voice control. Voice control can have several inconveniences related to privacy, noisy environments, and multi-user voice training, among other potential problems, whereas manipulating an input device with vision obscured and/or user hands otherwise occupied can be an unwanted distraction such as in an augmented or virtual reality environment.

It is thus desired to provide improved wearable devices, designs and processes that address these and other deficiencies. The above-described deficiencies are merely intended to provide an overview of some of the problems of conventional implementations and are not intended to be exhaustive. Other problems with conventional implementations and techniques and corresponding benefits of the various aspects described herein may become further apparent upon review of the following description.

### SUMMARY

The following presents a simplified summary of the specification to provide a basic understanding of some aspects of the specification. This summary is not an extensive overview of the specification. It is intended to neither identify key or critical elements of the specification nor delineate any scope particular to any embodiments of the specification, or any scope of the claims. Its sole purpose is to present some concepts of the specification in a simplified form as a prelude to the more detailed description that is presented later.

Devices and methods are provided that facilitate proximity or liveness detection of a user of a wearable device or a user interacting with a device based on ultrasonic information from an ultrasonic transceiver. In various embodiments, machine learning classifier models can be employed to generate classification predictions of a donned or a doffed state of a wearable device. In various aspects, a gated-recurrent unit (GRU) recursive neural network (RNN) can be employed as a machine learning classifier model. In other aspects, a liveness detection classifier decision tree can be employed as a machine learning classifier model. Power states or operating modes can be selected for associated devices based the proximity or liveness of the user of the wearable device, as an example.

These and other embodiments are described in more detail below.

### BRIEF DESCRIPTION OF THE DRAWINGS

Various non-limiting embodiments are further described with reference to the accompanying drawings in which:

FIG. 1 illustrates a block diagram of an exemplary, non-limiting apparatus or device that facilitates liveness and/or proximity detection in accordance with one or more embodiments described herein;

FIG. 2 illustrates another block diagram of an exemplary, non-limiting apparatus or device that facilitates liveness and/or proximity detection in accordance with one or more embodiments described herein;

FIG. 3 depicts a simplified block diagram of an exemplary, non-limiting ultrasonic transceiver system in package (UTSIP) apparatus or device that facilitates liveness and/or proximity detection in accordance with one or more embodiments described herein;

FIG. 4 depicts further non-limiting aspects regarding a UTSIP apparatus or device that facilitates liveness and/or proximity detection in accordance with one or more embodiments described herein;

FIG. 5 depicts non-limiting aspects regarding a UTSIP apparatus or device signal that can facilitate liveness and/or proximity detection in accordance with one or more embodiments described herein;

FIG. 6 depicts further non-limiting aspects regarding a UTSIP apparatus or device signal that can facilitate liveness and/or proximity detection in accordance with one or more embodiments described herein;

FIG. 7 depicts non-limiting aspects regarding liveness and/or proximity detection as further described herein;

FIG. 8 illustrates a block diagram of a non-limiting training processes for an exemplary apparatus or device that facilitates liveness and/or proximity detection in accordance with one or more embodiments described herein;

FIG. 9 depicts non-limiting aspects regarding a UTSIP apparatus or device signal that can facilitate liveness and/or proximity detection in accordance with one or more embodiments described herein;

FIG. 10 depicts further non-limiting aspects regarding a UTSIP apparatus or

device signal that can facilitate liveness and/or proximity detection in accordance with one or more embodiments described herein;

FIG. 11 depicts still further non-limiting aspects regarding a UTSIP apparatus or device signal that can facilitate liveness and/or proximity detection in accordance with one or more embodiments described herein;

FIG. 12 depicts a block diagram illustrating further non-limiting aspects of exemplary apparatuses or devices that facilitate liveness and/or proximity detection in accordance with one or more embodiments described herein;

FIG. 13 illustrates a block diagram of a non-limiting training processes for an exemplary apparatus or device that facilitates liveness and/or proximity detection in accordance with one or more embodiments described herein;

FIG. 14 depicts non-limiting aspects regarding a UTSIP apparatus or device signal that can facilitate liveness and/or proximity detection in accordance with one or more embodiments described herein;

FIG. 15 depicts further non-limiting aspects regarding a UTSIP apparatus or device signal that can facilitate liveness and/or proximity detection in accordance with one or more embodiments described herein;

FIG. 16 depicts a block diagram illustrating non-limiting aspects of exemplary apparatuses or devices that facilitate liveness and/or proximity detection in accordance with one or more embodiments described herein;

FIG. 17 depicts a block diagram illustrating further non-limiting aspects of exemplary apparatuses or devices that facilitate liveness and/or proximity detection in accordance with one or more embodiments described herein;

FIG. 18 illustrates a non-limiting flow diagram of exemplary methods that facilitate liveness and/or proximity detection in accordance with one or more embodiments described herein;

FIG. 19 illustrates another non-limiting flow diagram of exemplary methods that facilitate liveness and/or proximity detection in accordance with one or more embodiments described herein;

FIG. 20 illustrates another non-limiting flow diagram of exemplary methods that facilitate liveness and/or proximity detection in accordance with one or more embodiments described herein;

FIG. 21 illustrates a block diagram of an example, non-limiting operating environment in which one or more embodiments described herein can be facilitated;

FIG. 22 illustrates a sample computing environment operable to execute various implementations described herein;

FIG. 23 illustrates a block diagram of an exemplary, non-limiting apparatus or device that facilitates eye blink detection and/or classification in accordance with one or more embodiments described herein;

FIG. 24 illustrates another block diagram of an exemplary, non-limiting apparatus or device that facilitates eye blink detection and/or classification in accordance with one or more embodiments described herein;

FIG. 25 depicts non-limiting aspects regarding a UTSIP apparatus or device signal that can facilitate eye blink detection and/or classification in accordance with one or more embodiments described herein;

FIG. 26 depicts further non-limiting aspects regarding a UTSIP apparatus or device signal that can facilitate eye blink detection and/or classification in accordance with one or more embodiments described herein;

FIG. 27 depicts other non-limiting aspects regarding a UTSIP apparatus or device signal that can facilitate eye blink detection and/or classification in accordance with one or more embodiments described herein;

FIG. 28 depicts still further non-limiting aspects regarding a UTSIP apparatus or device signal that can facilitate eye blink detection and/or classification in accordance with one or more embodiments described herein;

FIG. 29 depicts another block diagram illustrating further non-limiting aspects of exemplary apparatuses or devices that facilitate eye blink detection and/or classification in accordance with one or more embodiments described herein;

FIG. 30 depicts non-limiting aspects regarding performance of eye blink detection and/or classification against annotated data sets according to various embodiments described herein; and

FIG. 31 illustrates a non-limiting flow diagram of exemplary methods that facilitate eye blink detection and/or classification in accordance with one or more embodiments described herein.

### DETAILED DESCRIPTION

### Overview

While a brief overview is provided, certain aspects of the subject disclosure are described or depicted herein for the purposes of illustration and not limitation. Thus, variations of the disclosed embodiments as suggested by the disclosed apparatuses, systems, and methodologies are intended to be encompassed within the scope of the subject matter disclosed herein.

As described above, it is of paramount importance in battery powered wearable devices (WD) or wearable computing devices that they are powered off or powered down to a low power state when not in use in addition to powering on quickly when device use is desired. As a result, improvements in proximity and/or liveness detection of human use or non-use of such devices are desired. It can be understood that long battery life is a user concern regardless of the type of battery-powered WD or wearable computing device that is encountered. Thus, while various embodiments are described herein in the context of virtual reality (VR) headsets or head mounted displays (HMDs), it can be understood that the various embodiments described herein are not limited to such end-user device applications.

As used herein, the term, “proximity” is used to describe a condition of nearness between two or more objects, such as in the sense of an ultrasonic transceiver and a user of interest for detection of a user using a device (e.g., VR headsets, HMDs, other devices for which proximity detection is of interest) or in proximity to a device. Thus, the detection of “proximity” is of concern where a sensor can sense an object such as a user within the sensor's detection range. In addition, as further used herein, the term, “liveness,” is used to refer to indications that set one inanimate object apart from a living object or portion thereof such as a body part intended or caused to be in proximity to a device, which could typically include some indication including an/or in addition to proximity. Accordingly, as used herein, determination of “liveness” can be based on proximity (e.g., detection of a user within the detection range of the ultrasonic transceiver 104/204) or a change in the proximity (e.g., variations in the detection of a user within the detection range of the ultrasonic transceiver), a physiological event detection (e.g., in the ultrasonic information provided by ultrasonic transceiver), a predetermined time delay (e.g., elapsed time), or a predetermined classification cycle delay (e.g., number of elapsed cycles of the ultrasonic transceiver of the application of the liveness classification algorithm). Note here that an exemplary determination of liveness can either be a positive liveness indication (e.g., that a human is wearing or is interacting with an appropriately configured device) or a negative indication (e.g., that a human has ceased wearing or interacting with an appropriately configured device). Thus, as used herein, “liveness” detection based on a physiological event detection can comprise one or more of a pulse rate detection, a circulatory flow detection, a respiratory event detection, an eye movement detection, an eye blink detection, a facial movement detection, a facial expression change detection, a muscular movement detection, and the like, without limitation. Accordingly, while the various embodiments are described herein in terms of exemplary liveness detection and power management schemes, it can be appreciated that the various disclosed embodiments can be employed to leverage the ultrasonic transceiver “liveness” indication detections can be employed in further applications, including, but not limited to, controlling a user interface, issuing device commands, rendering audio or video data to a user based on users perceived focus, and so on, based on the detection the “liveness” indication.

For instance, the various embodiments described herein that facilitate proximity and/or liveness detection can find applicability in other battery-powered WD or wearable computing device contexts such as for augmented reality (AR) glasses, headphones, smart watches, fitness trackers, wearable monitors such as heart monitors, and similar devices. Moreover, the various embodiments described herein that facilitate proximity and/or liveness detection can find applicability in other battery-powered computing device contexts that are closely associated with active human use interspersed with periods of inactivity, regardless of whether the devices can be strictly defined as “wearable,” such as smart phones, video game controllers, and the like. Accordingly, it can be understood that, while the various embodiments described herein that facilitate proximity and/or liveness detection are described in terms of VR headsets HMDs, the herein appended claims are not strictly limited to such applications.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

### EXEMPLARY EMBODIMENTS

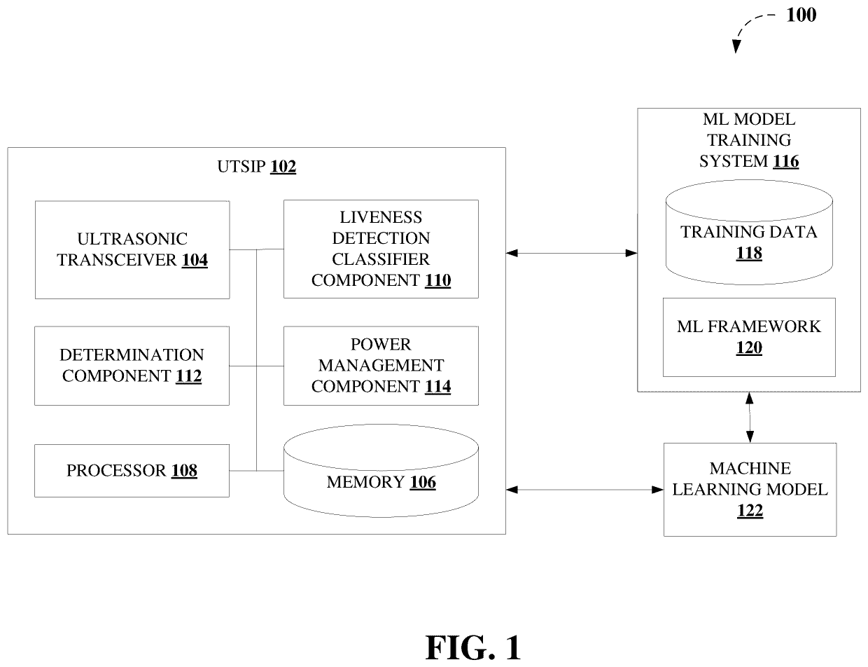

FIG. 1 illustrates a block diagram 100 of an exemplary, non-limiting apparatus or device that facilitates liveness and/or proximity detection in accordance with one or more embodiments described herein. For instance, an exemplary, non-limiting apparatus or device can comprise a UTSIP 102 that facilitates liveness and/or proximity detection in accordance with one or more embodiments described herein. In a nonlimiting aspect, exemplary UTSIP 102 can comprise or be associated with an ultrasonic transceiver 104, such as an ultrasonic Time-of-Flight (ToF) transceiver that facilitates liveness and/or proximity detection in accordance with one or more embodiments described herein.

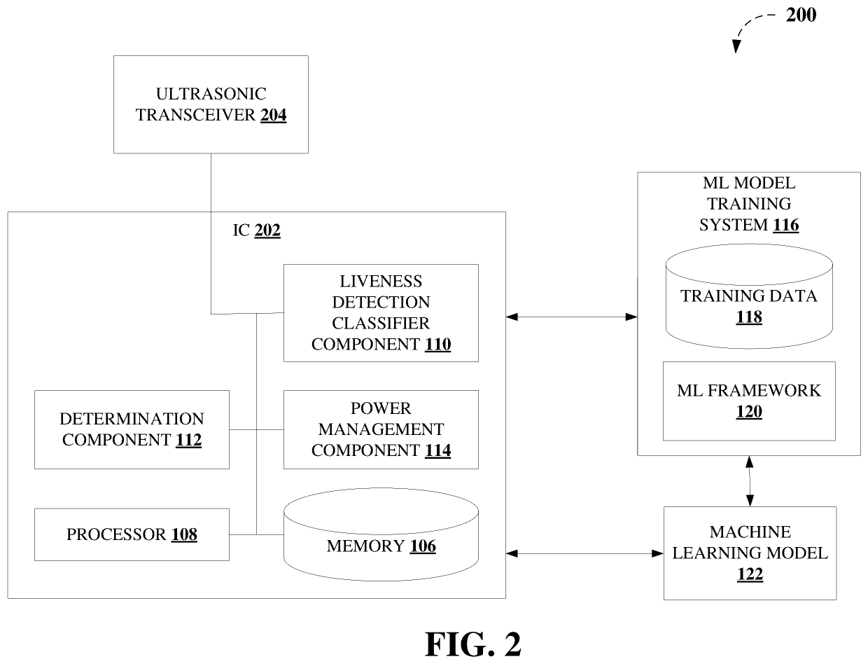

FIG. 2 illustrates another block diagram 200 of an exemplary, non-limiting apparatus or device that facilitates liveness and/or proximity detection in accordance with one or more embodiments described herein. As an example, an exemplary, non-limiting apparatus or device can comprise an integrated circuit (IC) 202 that facilitates liveness and/or proximity detection in accordance with one or more embodiments described herein. In a nonlimiting aspect, exemplary IC 202 can comprise or be associated with an ultrasonic transceiver 204, such as an ultrasonic ToF transceiver that facilitates liveness and/or proximity detection in accordance with one or more embodiments described herein.

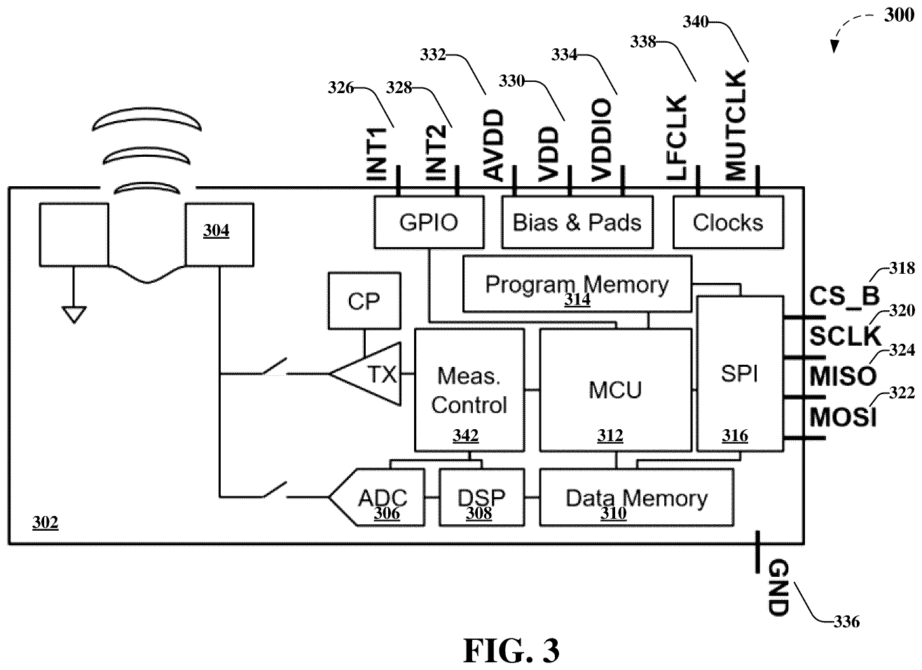

Thus, while FIG. 1 depicts a UTSIP 102 that can comprise an ultrasonic transceiver 104, such as might be provided by an ultrasonic transceiver 104 integrated with a processor and memory as a system-in-package, as further described below regarding FIG. 3, FIG. 2 depicts IC 202 that can be associated with a discrete ultrasonic transceiver 204, both of which can facilitate liveness and/or proximity detection in accordance with one or more embodiments described herein. In either case, exemplary integrated ultrasonic transceiver 104 or discrete ultrasonic transceiver 204 can be configured to generate ultrasonic time of flight range information to facilitate liveness and/or proximity detection in accordance with one or more embodiments described herein.

In a further non-limiting aspect, exemplary ultrasonic transceiver 104/204 can be positioned within the wearable device such that the field of view of the ultrasonic transceiver 104/204 will cover one or more body part or portions thereof of the user in wearing or operation of the device. As described above, liveness and/or proximity detection for battery-powered devices in accordance with one or more embodiments described herein may be useful in device contexts other than wearable devices, regardless of whether the devices can be strictly defined as “wearable,” for example such as for smart phones, video game controllers, and the like. Thus, exemplary ultrasonic transceiver 104/204 can be positioned within the device such that the field of view of the ultrasonic transceiver 104/204 will interact with one or more body part or portions thereof of the user in expected operation of the device. In either case, exemplary ultrasonic transceiver 104/204 can be positioned within the device such that the ultrasonic transceiver 104/204 can be expected to experience movement relative to the exemplary ultrasonic transceiver 104/204 when the wearable device is being worn by the user or the device is interacting or operating the device.

In various embodiments, exemplary UTSIP 102 or IC 202 can comprise or be associated with one or more computer-readable memory, such as memory 106. In further embodiments, exemplary UTSIP 102 or IC 202 can comprise or be associated with one or more processors, such as, for example, processor 108, that can be configured to execute computer-executable components stored in a computer-readable memory (e.g., memory 106).

As a non-limiting example, computer-executable components that can be executed by processor 108 can comprise a liveness detection classifier component 110 that facilitates liveness and/or proximity detection in accordance with one or more embodiments described herein. For instance, an exemplary liveness detection classifier component 110 can be configured as described herein to generate a classification of ultrasonic information (e.g., received from ultrasonic transceiver 104) as indicative of proximity and/or liveness of a user of a wearable device comprising exemplary UTSIP 102 or IC 202 via a liveness classification algorithm, for example, as further described herein.

As another non-limiting example, computer-executable components that can be executed by processor 108 can comprise a determination component 112 that facilitates liveness and/or proximity detection in accordance with one or more embodiments described herein. For instance, an exemplary determination component 112 can be configured to generate a determination of proximity and/or liveness of the user of the wearable device based on the classification (e.g., via exemplary liveness detection classifier component 110), for example, as further described herein.

In a non-limiting aspect, an exemplary determination of liveness can be based on proximity (e.g., detection of a user within the detection range of the ultrasonic transceiver 104/204) or a change in the proximity (e.g., variations in the detection of a user within the detection range of the ultrasonic transceiver 104/204), a physiological event detection (e.g., in the ultrasonic information provided by ultrasonic transceiver 104/204), a predetermined time delay (e.g., elapsed time), or a predetermined classification cycle delay (e.g., number of elapsed cycles of the ultrasonic transceiver 104/204 of the application of the liveness classification algorithm). Note here that an exemplary determination of liveness can either be a positive liveness indication (e.g., that a human is wearing or is interacting with an appropriately configured device) or a negative indication (e.g., that a human has ceased wearing or interacting with an appropriately configured device). In a further non-limiting aspect, an exemplary physiological event detection can comprise one or more of a pulse rate detection, a circulatory flow detection, a respiratory event detection, an eye movement detection, an eye blink detection, a facial movement detection, a facial expression change detection, a muscular movement detection, and the like, without limitation. In still further non-limiting aspects, an exemplary determination component 112 can be configured to generate a determination of proximity and/or liveness of the user of the wearable device based on the classification (e.g., via exemplary liveness detection classifier component 110) and on one or more other inputs, either available by one or more sensors (not shown) associated with exemplary determination component 112, or otherwise. For example, further non-limiting embodiments can include or be associated with one or more sensors (not shown) other than an ultrasonic sensor, e.g., infrared sensor, temperature sensor, accelerometer, gyroscope, environmental sensor, acoustic sensor, and so on, without limitation, and exemplary determination component 112 can be configured to process such inputs in addition to the classification (e.g., via exemplary liveness detection classifier component 110) to facilitate generating a determination of proximity and/or liveness of the user of the wearable device.

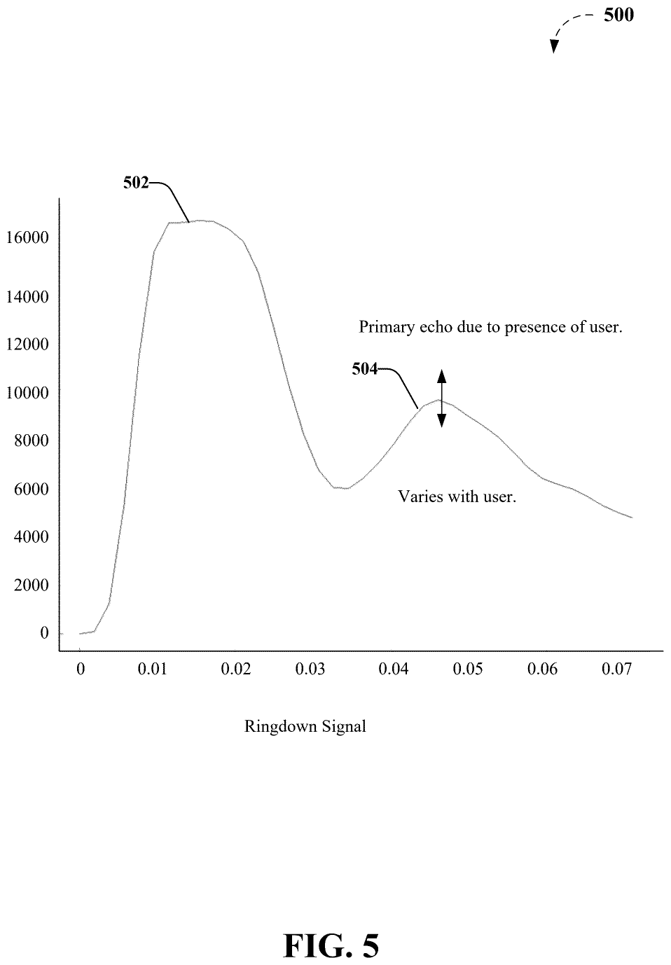

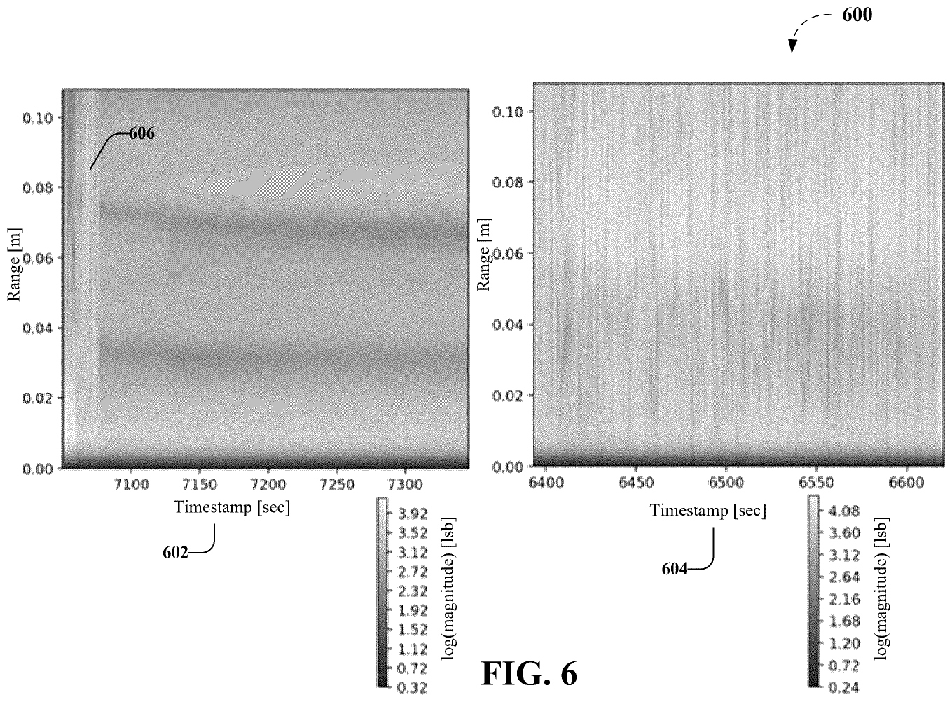

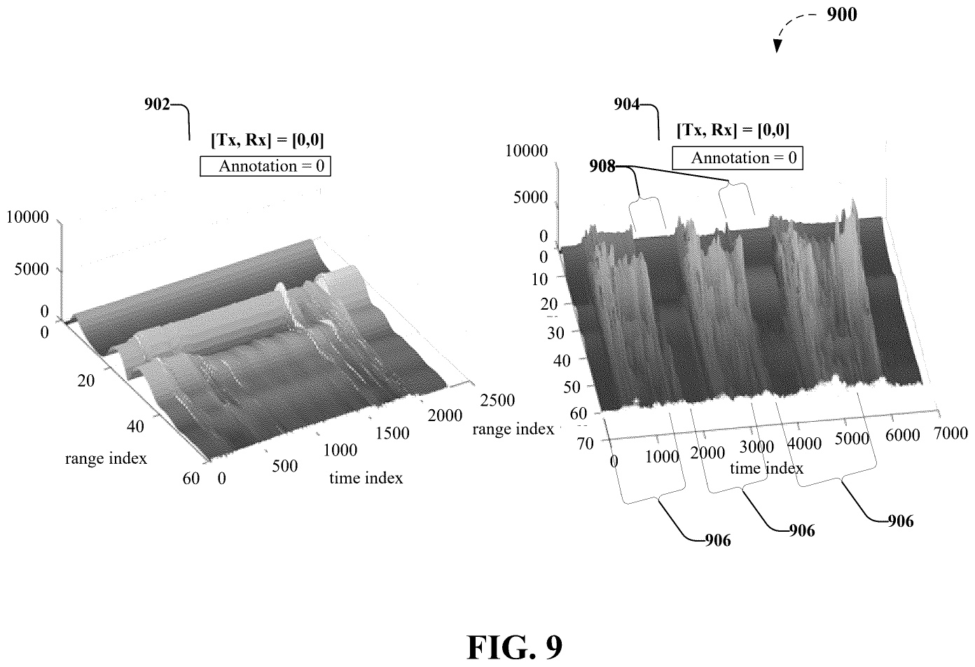

For instance, exemplary ultrasonic transceiver 104/204 can be configured to emit ultrasonic pulses and receive echoes as ultrasonic information, as further described herein regarding FIGS. 5-6. In yet another non-limiting aspect, an exemplary liveness classification algorithm as described herein can be configured to analyze expected echoes of the ultrasonic pulses on the user to determine whether the wearable device is being worn by the user or is being used in the case of other battery-powered devices. In still further non-limiting aspects, exemplary determination component 112 can be configured to generate the determination of the proximity or liveness of the user of the wearable device as a donned state or as a doffed state of the wearable device, for example, as further described herein regarding FIG. 9.

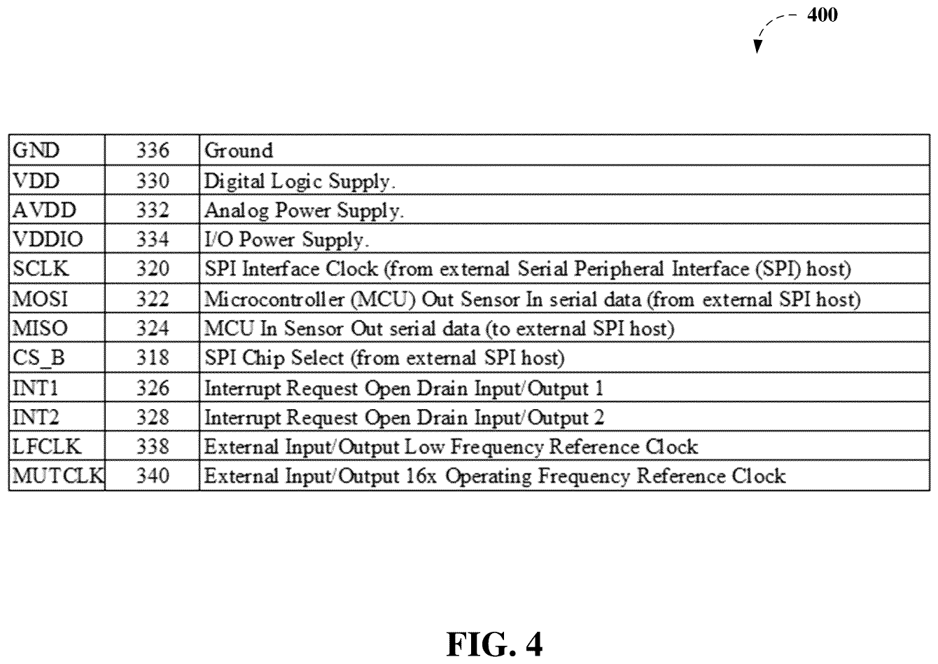

In other non-limiting embodiments, computer-executable components that can be executed by processor 108 can comprise a power management component 114 that facilitates controlling power states of the wearable device based on the liveness and/or proximity detection in accordance with one or more embodiments described herein. For instance, an exemplary power management component 114 can be configured as described herein to select a power state or an operating mode of the wearable device based the determination (e.g., via exemplary determination component 112) of the proximity and/or liveness of the user of the wearable device, for example, as further described herein. While not shown in FIGS. 1 and 2, exemplary UTSIP 102 or IC 202 can comprise or be associated with various communications and I/O functionality (e.g., serial peripheral interface (SPI), general purpose I/O (GPIO), and so on for the purpose of communications and control among exemplary UTSIP 102 or IC 202 and a host system such as a host processor, an applications processor, and the like to facilitate selecting a power state or an operating mode of the wearable device (or other battery-powered device) based the determination (e.g., via exemplary determination component 112) of the proximity and/or liveness of the user of the wearable device (or other device), for example, as further described herein regarding FIGS. 3-4.

In various embodiments described herein, an exemplary liveness classification algorithm can be based on a machine learning (ML) model trained on captured and classified ultrasonic information received during a number of states of use of a test wearable device (or a test device for non-wearable devices). For instance, FIGS. 1 and 2 depict exemplary UTSIP 102 or IC 202 associated with exemplary machine learning (ML) model training system 116. In non-limiting aspects, exemplary ML model training system 116 can comprise or be associated with a body training data 118, which typically comprises a database of labeled data, wherein the labeled data comprises a set of observations of the data of interest (here, echoes of the transmitted ultrasonic pulses from a test device comprising ultrasonic transceiver 104/204) labeled with classifications of the data), with which the exemplary ML model training system 116 can employ an exemplary ML framework 120 to generate an exemplary ML model 122.

ML frameworks provide software libraries and application programming interfaces (APIs) for tasks like data preprocessing, model building, and the like to facilitate development of ML models such as exemplary ML model 122. One popular ML framework is TensorFlow, which can be used to develop an exemplary ML model 122, for example, as further described herein. As a non-limiting example, exemplary ML model training system 116 can be employed to produce an exemplary ML model 122 for the classification of ultrasonic information as indicative of proximity or liveness of a user of a wearable device (or a device in use). Thereafter, specific implementations of the exemplary ML model 122 can be compiled for specific hardware implementations such as exemplary UTSIP 102 or IC 202 in conjunction with ultrasonic transceiver 104/204, for example to produce an exemplary liveness detection classifier component 110, exemplary determination component 112, and the like that facilitate liveness and/or proximity detection in accordance with one or more embodiments described herein.

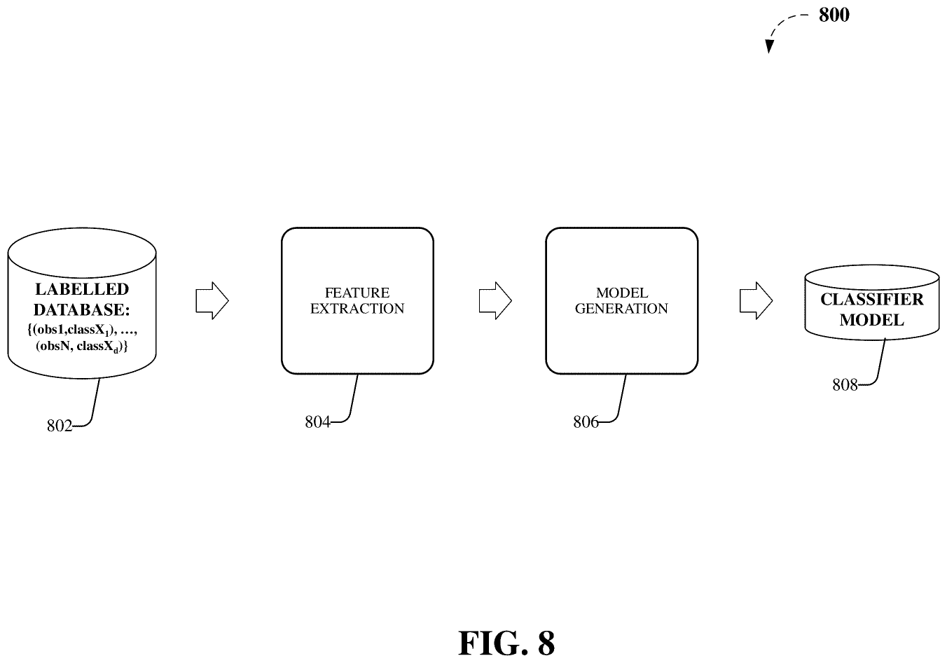

These hardware specific ML model components can be stored in one or more computer-readable memory, such as memory 106, associated with exemplary UTSIP 102 or IC 202, and one or more processors such as exemplary processor 108 can be configured to execute the computer-executable ML model components (e.g., exemplary liveness detection classifier component 110, exemplary determination component 112, and the like) stored in the computer-readable memory (e.g., memory 106) to facilitate liveness and/or proximity detection in accordance with one or more embodiments described herein. Further description of training and execution of various embodiments that employ ML models to facilitate liveness and/or proximity detection are provided regarding specific non-limiting implementations, for example, regarding FIGS. 8-11 and FIGS. 12-14. It can be appreciated that once the computer-executable ML model components (e.g., exemplary liveness detection classifier component 110, exemplary determination component 112, and the like) are deployed and stored in the computer-readable memory (e.g., memory 106) to facilitate liveness and/or proximity detection in accordance with one or more embodiments described herein, the exemplary ML model training system 116 is no longer necessary to the normal operation of the exemplary, non-limiting UTSIP apparatus or device 102, IC apparatus or device 202 and so. However, it can be further appreciated that data obtained by non-limiting UTSIP apparatus or device 102, IC apparatus or device 202, and classifications made thereon can be back-propagated to exemplary ML model training system 116, for example, to improve the training data 118, create and/or retrain exemplary ML model 122, and so on, according to further non-limiting aspects.

FIG. 3 depicts a simplified block diagram 300 of an exemplary, non-limiting ultrasonic transceiver system in package (UTSIP) apparatus or device 302 that facilitates liveness and/or proximity detection in accordance with one or more embodiments described herein. FIG. 4 depicts further non-limiting aspects regarding a UTSIP apparatus or device 302 that facilitates liveness and/or proximity detection in accordance with one or more embodiments described herein. For instance, FIG. 3 depicts exemplary UTSIP apparatus or device 302 as a system-in-package that can comprise an ultrasonic ToF transceiver 304 integrated with a system on chip (SoC). In a non-limiting aspect, ultrasonic ToF transceiver 304 can comprise a piezoelectric micromachined ultrasonic transducer (PMUT). In another non-limiting aspect, exemplary ultrasonic ToF transceiver 304 can operate at a nominal operating frequency (Fop) of 175 kiloHertz (kHz). In addition, UTSIP apparatus or device 302 can comprise digital circuitry (e.g., analog to digital converter ADC 306, digital signal processor (DSP) 308) to process and buffer (e.g., via data memory 310) the raw sensor readings (e.g., ultrasonic information), an integrated microcontroller (MCU) 312, which can process the raw sensor readings into derivative signals, such as range to nearby target(s), or events, such as presence, proximity, liveness, according to computer executable components stored in program memory 314 which can be directly read by a host processor or application processor (not shown).

Exemplary UTSIP apparatus or device 302 can communicate with a host processor (not shown) via serial peripheral interface component (SPI) 316, facilitated by SPI chip select CS_B 318 (from external SPI host (not shown)), SPI Interface Clock SCLK 320 (e.g., from external SPI host (not shown)), SPI chip select CS_B 320 (from external SPI host (not shown)), MCU Out Sensor In serial data MOSI 322 (from external SPI host (not shown)), and MCU In Sensor Out serial data MISO 324 (to external SPI host (not shown)). Exemplary UTSIP apparatus or device 302 can further support general purpose IO (GPIO) for example, via interrupt request (INT1 326, INT2 328), which can be used as a system wake-up source when a measurement is ready. Exemplary UTSIP apparatus or device 302 can be supplied by digital logic supply VDD 330, analog power supply AVDD 332, I/O power supply VDDIO 334, with exemplary UTSIP apparatus or device 302 tied to ground GND 336. Exemplary UTSIP apparatus or device 302 can receive a clock signal via external I/O low frequency reference clock LFCLK 338 and external I/O 16x operating frequency reference clock MUTCLK 340 is controlled to 16 times the operating frequency (transmit and receive) (Fop).

Thus, FIGS. 3-4 provide an ultrasonic transceiver such as ultrasonic transceiver 104 and the system-on-chip (SoC) that can be configured to control (e.g., via measurement control 342) the ultrasonic transceiver to produce pulses of ultrasound at a specified operating frequency (e.g., transmit and receive) (Fop), which pulses can reflect off targets in the sensor's field of view (FoV), which reflections can be received by the ultrasonic transceiver after a short time delay, amplified, digitized, and stored as I/Q data (e.g., component of the signal in-phase with cosine demodulator is in-phase (I) and in-phase with sine demodulator is called quadrature (Q)) in data memory 310. As further described herein, software defined algorithms (e.g., stored in program memory 314) can process the I/Q data to detect targets via MCU 312, which algorithms can be tuned to detect stationary or moving targets, determine proximity and/or liveness of a user (e.g., via a liveness detection classifier component 110, a determination component 112) of a device comprising or associated with exemplary UTSIP apparatus or device 302. As further described herein, I/Q data and/or other instructions (e.g., via a power management component 114) can also be transferred to a larger host or application processor for further processing and/or control.

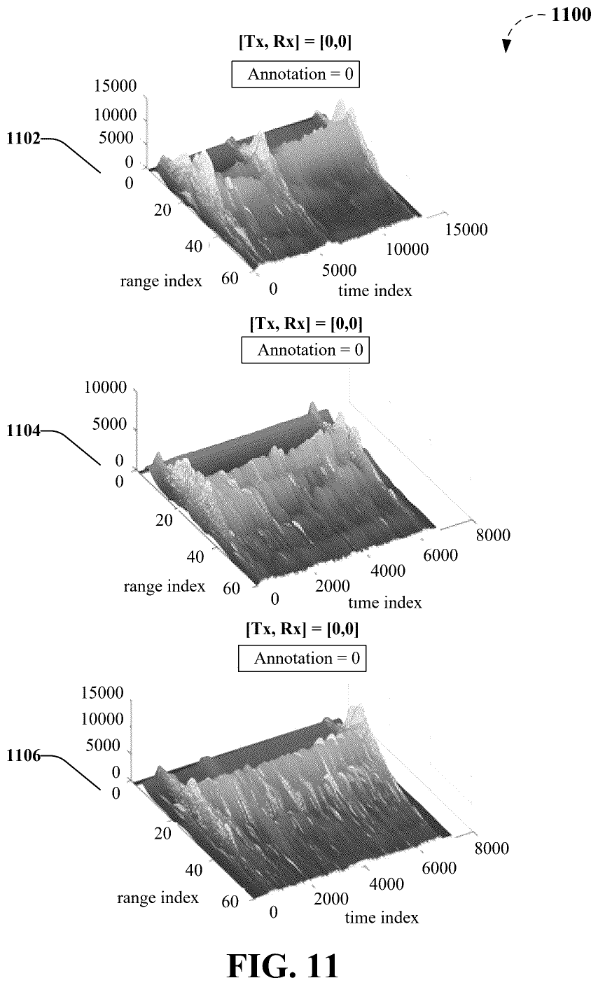

FIG. 5 depicts non-limiting aspects 500 regarding a UTSIP apparatus or device (e.g., exemplary UTSIP 102, exemplary IC 202 with ultrasonic transceiver 204, exemplary UTSIP apparatus or device 302) signal that can facilitate liveness and/or proximity detection in accordance with one or more embodiments described herein. For instance, FIG. 5 depicts a single exemplary ultrasonic pulse, echo response (e.g., ringdown 502) of an ultrasonic signal reflecting of an object such as a user or person within detection range of the UTSIP apparatus or device (e.g., exemplary UTSIP 102, exemplary IC 202 with ultrasonic transceiver 204, exemplary UTSIP apparatus or device 302), where the primary echo 504 is due to a user or person being in the path of the ultrasonic pulse. FIG. 5 further depicts that primary echo 504 can vary based on the user, for example, as further described herein regarding FIG. 11.

In the non-limiting example of a wearable device such as a VR headset with an exemplary UTSIP apparatus or device (e.g., exemplary UTSIP 102, exemplary IC 202 with ultrasonic transceiver 204, exemplary UTSIP apparatus or device 302) placed so that the ultrasonic transceiver is facing a user forehead, the distance between exemplary UTSIP apparatus or device (e.g., exemplary UTSIP 102, exemplary IC 202 with ultrasonic transceiver 204, exemplary UTSIP apparatus or device 302) and the user's forehead is typically constrained by the VR headset construction. As a result, in situations where the VR headset is not worn, there should be no primary echo 504, however, as depicted in FIG. 5 an amount of variability in the primary echo 504 can be experienced (e.g., due to blood flow, facial motion, breathing). Thus, as further described herein, as a result of variability of signals between user to user and within user (e.g., from glasses, sweating, active versus passive use) conventional signal processing solutions (e.g., digital signal processing, fast Fourier transforms) may not be able to provide reliable classification of reflected pulse, unlike the provided liveness and/or proximity detection and classification methods that can learn such variability in accordance with one or more embodiments described herein.

FIG. 6 depicts further non-limiting aspects 600 regarding an exemplary UTSIP apparatus or device (e.g., exemplary UTSIP 102, exemplary IC 202 with ultrasonic transceiver 204, exemplary UTSIP apparatus or device 302) signal that can facilitate liveness and/or proximity detection in accordance with one or more embodiments described herein. FIG. 5 depicted a single pulse-echo response to illustrate the variability in the primary echo 504 due to a user within detection range of the exemplary UTSIP apparatus or device (e.g., exemplary UTSIP 102, exemplary IC 202 with ultrasonic transceiver 204, exemplary UTSIP apparatus or device 302). In reality, exemplary UTSIP apparatus or device (e.g., exemplary UTSIP 102, exemplary IC 202 with ultrasonic transceiver 204, exemplary UTSIP apparatus or device 302) rapidly generates pulse that are transmitted and echo or reflections that are received. FIG. 6 depicts two-dimensional contour plots 602 604 of the raw data of the transmitted pulses and received echoes over time, where contour plot 602 depicts a test device in its storage bag, with indicated motion 606 shown as a result of zipping the bag, and where contour plot 604 depicts a user playing a sedentary game. It can be understood that motion of the user's face such as blinking (e.g., average adults blink 12-15 times per minute), changing facial expressions (e.g., squints, smiles, frowns, raised eyebrows, and the like) all have the capacity to vary the primary echo 504, further exacerbating the difficulty in defining a robust and accurate proximity or liveness classifier based on conventional signal processing solutions.

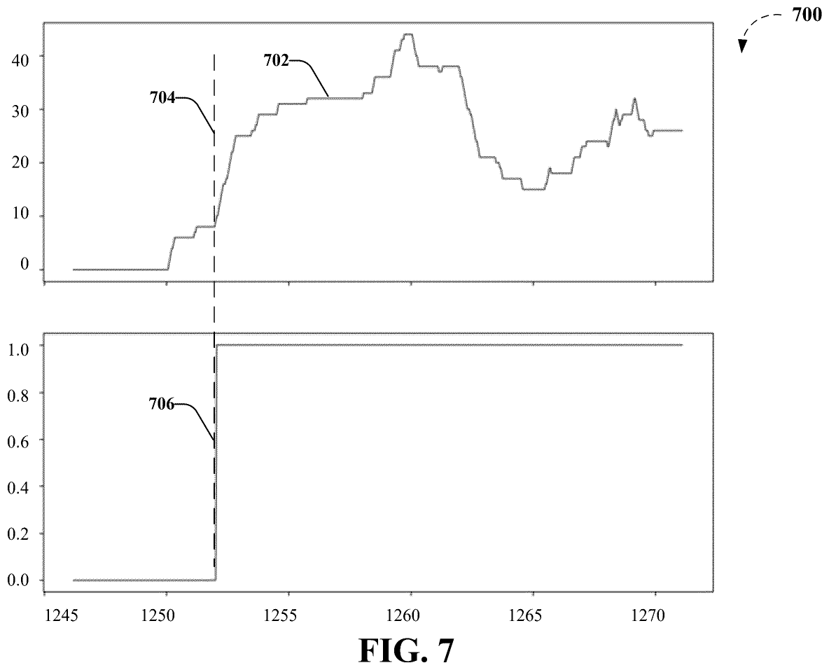

As an example, FIG. 7 depicts non-limiting aspects regarding liveness and/or proximity detection as further described herein. For instance, FIG. 7 depicts one potential conventional signal processing approach to classification in the form of a digital signal processing algorithm that might be employed using exemplary UTSIP apparatus or device 302. For instance, an exemplary wandering algorithm can count the number of target detections (e.g., an echo magnitude greater than a first predetermined threshold) 702 that happen in a configurable-length window, where echo magnitude is configured to look for changes in the signal (e.g., long term average is subtracted). If the number of target detection 702 events in the window exceeds a second predetermined threshold 704, it can be concluded that there is wandering activity (or liveness) in the pulse echo signal. Thus, FIG. 7 depicts the number of target detection 702 events that exceed the second predetermined threshold 704 (e.g., ten in FIG. 7), and user wandering activity (or liveness) 706 is classified. Note that when the number of target detection 702 events crosses the second predetermined threshold 704 (e.g., ten in FIG. 7), user wandering activity (or liveness) 704 can be classified 706 as live (or wearable device on/donned).

However, FIG. 7 reveals some weaknesses with conventional signal processing algorithms. For instance, FIG. 7 does not include variations in users, where the echo magnitude variations between users suggest that one single first predetermined threshold may not work with different users. Likewise, sensor-to-sensor variations may require unique settings to accommodate a crude conventional signal processing algorithm. Whereas the wandering algorithm for a single user may sufficiently classify activity for that one user, one sensor combination to distinguish between device being worn and sensor being blocked by inanimate object (e.g., head-strap, inside case/bag), other conventional signal processing algorithms may find more difficulty.

Accordingly, due to the variety and size of the data that must be analyzed to develop a successful classification algorithm, various disclosed embodiments can employ a machine learning algorithm to facilitate liveness and/or proximity detection and classification thereof as further described herein. Thus, the various disclosed embodiments can detect when user is putting the headset on (or other wearable device, or other device interaction), e.g., “donned,” and turn the device on, where a donning event can result in a “worn” state being set to 1 in a particular non-limiting embodiment. In addition, the various disclosed embodiments provide robust detection, regardless of wearable device or device usage (e.g., user moving, user not moving, user interactions in addition to detected interaction), resulting in “worn” remaining equal to 1 in a particular non-limiting embodiment. Moreover, the various disclosed embodiments can provide low latency, e.g., from liveness and/or proximity detection and classification to device power on less than about a second.

In addition, the various disclosed embodiments can detect when user is removing the headset (or other wearable device, or other device interaction), e.g., “doffed,” and turn the device of, where a doffing event can result in a “worn” state being set to 0 in a particular non-limiting embodiment. In addition, the various disclosed embodiments provide robust detection, regardless of wearable device or device usage, resulting in “worn” remaining equal to 0 in a particular non-limiting embodiment, without false triggers while the headset (or other device) is not being used (headset/device stored in its storage box, headset/device put in a bag and user walking). Moreover, the various disclosed embodiments can provide low latency, e.g., from liveness and/or proximity detection and classification to device power off less than about five seconds to provide improved battery life.

FIG. 8 illustrates a block diagram 800 of a non-limiting training processes for an exemplary apparatus or device that facilitates liveness and/or proximity detection in accordance with one or more embodiments described herein. Thus, exemplary ML model training system 116 can comprise or be associated with a body of training data 118 such as labelled database 802, which can comprise ultrasonic transceiver observations (e.g., pulse-echo) in the form of I/Q data as described above regarding FIG. 3, for instance, time stamps, and classifications which data is labelled or annotated according to a desired output state (e.g., donned, doffed). In addition, exemplary ML framework 120 can facilitate any data preprocessing such as filtering, normalization, higher level feature extraction, and so on for the observations in labelled database 802, in non-limiting aspects. It can be understood that, depending on the classifier technology employed, this can boost final performances or minimize classifier model size, in further non-limiting aspects. Next, exemplary ML framework 120 can facilitate feature extraction 804, which can transform the observations to feature vectors, which feature vectors and respective annotations can be stored for subsequent use.

In further embodiments, exemplary ML framework 120 can facilitate ML model generation 806, as further described herein regarding FIGS. 1-2. For instance, an exemplary ML framework 120 can generate several models, with various classifier types being possible including a decision tree, random forest, support vector machine (SVM), and/or neural networks (e.g., including tiny DNN, RNN) and the like. Thus, while various disclosed embodiments are described in non-limiting terms of a decision tree classifier, a RNN, a GRU RNN, the disclosed subject matter is not so limited. Accordingly, various non-limiting embodiments can facilitate liveness and/or proximity detection in accordance with one or more embodiments described herein by employing any of a number of machine learning methods, including but not limited to, random forest, gradient boosting decision tree, SVM, logistic regression, neural networks, naive bayes, gaussian mixture models, etc. In another non-limiting aspect, exemplary ML framework 120 can facilitate ML model generation 806 by splitting feature vectors into training, testing, and validation sets, and finding one or more rules (e.g., using the training set) that produces accurate predictions (e.g., on the testing set). Thus, exemplary ML framework 120 can facilitate ML model generation 806 by facilitating the selection of the model with the highest accuracy on the testing set, where, if ML model accuracy on the validation set is similar to that for the testing set, it can be concluded that the model is generalizing well and the ML model 122 (e.g., ML classifier model 808) can be compiled and propagated to an exemplary UTSIP apparatus or device (e.g., exemplary UTSIP 102, exemplary IC 202 with ultrasonic transceiver 204, exemplary UTSIP apparatus or device 302), as further described herein.

FIG. 9 depicts non-limiting aspects 900 regarding a UTSIP apparatus or device signal that can facilitate liveness and/or proximity detection in accordance with one or more embodiments described herein. For instance, FIG. 9 depicts three dimensional contour plots 902, 904 of an exemplary pulse-echo response 902 for a test device in a storage bag with user walking, and an exemplary pulse-echo response 904 for a test device with user alternatively donning and doffing the wearable device, where donned 906 shows significant target detection and variability in the pulse-echo response 904, and where doffed 908 shows minimal target detection and variability in the pulse-echo response 904. Note that FIG. 9 depicts pulse-echo response 902 as 0 for range index approximately 60 (e.g., no user expected outside of that range). The data in FIG. 9 was obtained at an output data rate of 5, frame rate of 50 Hz, with ultrasonic transceiver directed roughly at the center of the forehead on a wearable HMD test device, with a detection range of 38 millimeters (mm) to 256 mm.

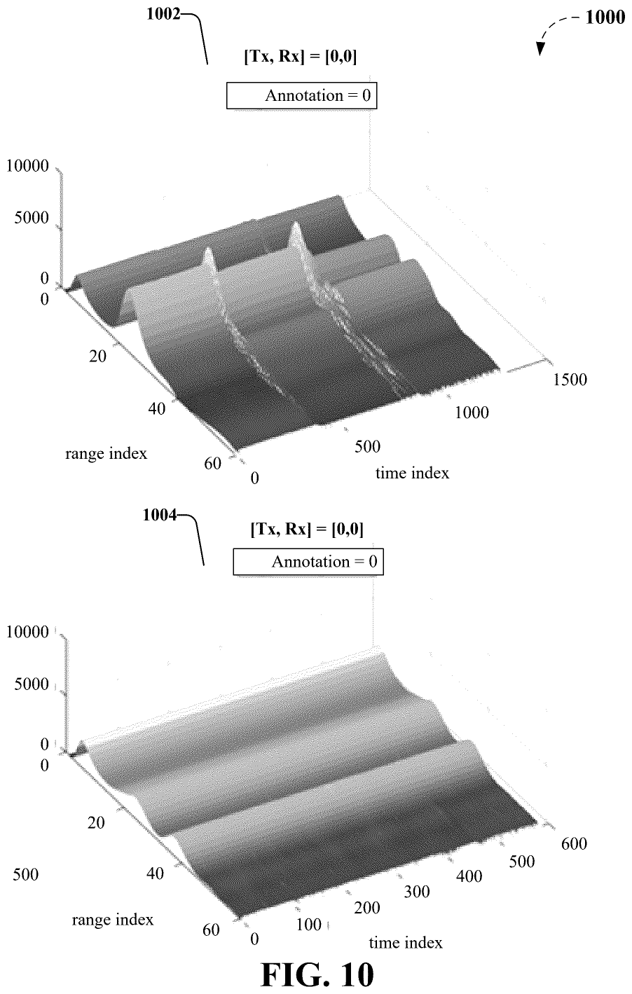

FIGS. 10-11 depict further non-limiting aspects 1000/1100 regarding a UTSIP apparatus or device signal that can facilitate liveness and/or proximity detection in accordance with one or more embodiments described herein. Whereas FIG. 10 depicts wearable HMD test device in a doffed 908 state, either at rest in a case 1002, or at rest on a table 1004, FIG. 11 depicts wearable HMD test device in a donned 906 state, for a first user 1102, for a second user 1104, and for a third user 1106. FIG. 11 demonstrates the substantial user to user variability in the pulse-echo that would make a conventional signal processing classifier difficult and likely error prone.

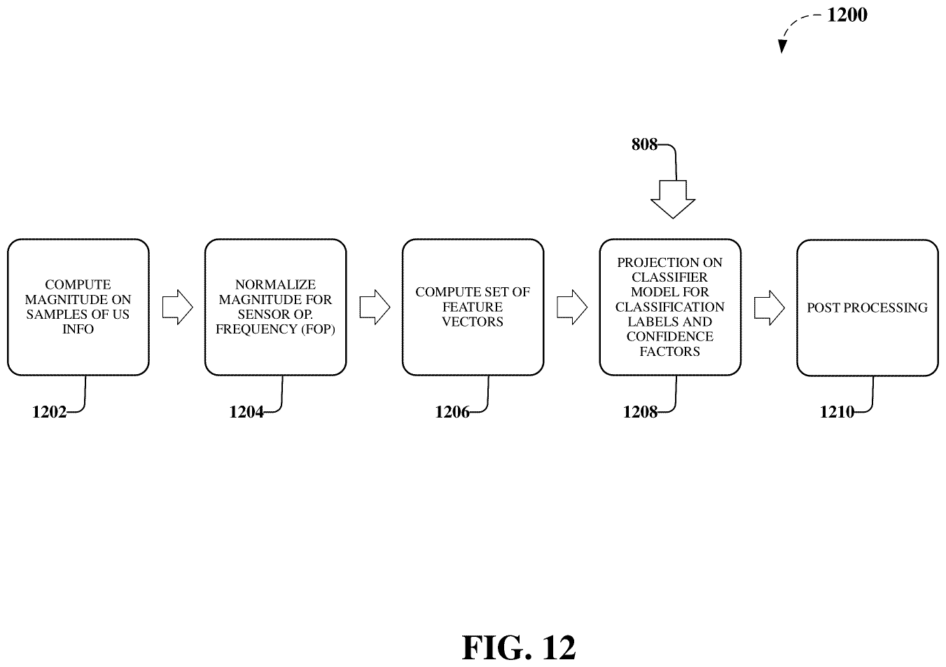

FIG. 12 depicts a block diagram 1200 illustrating further non-limiting aspects of exemplary apparatuses or devices that facilitate liveness and/or proximity detection in accordance with one or more embodiments described herein. For instance, FIG. 12 depicts runtime processes for an exemplary liveness classification algorithm including a ML model 122 (e.g., ML classifier model 808) that can be compiled and propagated to an exemplary UTSIP apparatus or device (e.g., exemplary UTSIP 102, exemplary IC 202 with ultrasonic transceiver 204, exemplary UTSIP apparatus or device 302), as further described herein along with and preprocessing and postprocessing of ultrasonic information before and after classifier model 808 classification.

In a non-limiting aspect, exemplary liveness classification algorithm in a ML model 122 (e.g., ML classifier model 808) can comprise a liveness detection classifier decision tree trained on captured and classified ultrasonic information received during a set of states of use of a test wearable device (or other device). As a non-limiting example, the exemplary liveness classification algorithm can be executed on every new frame of pulse-echo ultrasonic information (e.g., with roughly 7 to 25 frames/second). As further described herein regarding FIGS. 1-2, for example, an exemplary liveness detection classifier component 110 can be configured to generate the classification of the ultrasonic information as indicative of the proximity or the liveness based on the liveness classification algorithm.

Accordingly, exemplary liveness classification algorithm can be configured to compute magnitude of samples of ultrasonic information at 1202. In addition, exemplary liveness classification algorithm can be further configured to normalize the magnitude of samples of ultrasonic information as a function of ultrasonic transceiver (e.g., ultrasonic transceiver 104/204/304) operating frequency (Fop) at 1204 to generate normalized magnitude ultrasonic information. Furthermore, exemplary liveness classification algorithm can be further configured to compute a set of feature vectors in the normalized magnitude ultrasonic information at 1206.

Moreover, exemplary liveness classification algorithm can be further configured to determine a set of feature classification labels (e.g., for the computed feature vectors) and corresponding confidence factors using the liveness detection classifier decision tree at 1208 to generate an overall classification label and a confidence factor. Accordingly, exemplary determination component 112 can be configured to generate the determination of the proximity or liveness based on the set of feature classification labels and corresponding confidence factors.

In addition, exemplary liveness classification algorithm can comprise classifier post processing at 1210. If the confidence factor for the classification is greater than a threshold for the classification, then the liveness detection classifier decision tree can facilitate generating the donned or doffed state (e.g. based on a recursive average of a number of samples of confidence factors (e.g., 2 confidence factors)), the averaged confidence factor, and the classifier detection as an output.

In another non-limiting aspect, if it is determined that the don-doff latency is excessive, various embodiments described herein can further include an eye blink detection classification component (not shown), for example, as further described herein regarding FIG. 2. For instance, exemplary determination component 112 can be further configured to generate the determination of the proximity or liveness of the user of the wearable device as the donned or the doffed state of the wearable device, based on an eye blink detection classification component (determination) determination of an eye blink or repeated cycles of a determined doff state. As a non-limiting example, if no eye blink is detected after a predetermined time, an exemplary eye blink detection classification component can generate a doffed determination, notwithstanding any latency in the decision tree classifier ML model portion of the exemplary liveness classification algorithm. Otherwise, to avoid premature and erroneous doffed state being determined, a doffing even can be precluded until repeated cycles of a determined doff state has been provided by the decision tree classifier ML model portion of the exemplary liveness classification algorithm.

Accordingly, various embodiments as described herein can provide an exemplary UTSIP apparatus or device (e.g., exemplary UTSIP 102, exemplary IC 202 with ultrasonic transceiver 204, exemplary UTSIP apparatus or device 302) that can facilitate liveness and/or proximity detection based on a decision tree-based ML model 808 as further described herein. For instance, an exemplary decision tree based ML model 808 having depth of 6 and 8 feature extraction zones, when incorporating the decision tree classifier ML model portion of the exemplary liveness classification algorithm with optimization of false negative (doff) rate by rejection of doffing event until several consecutive doff frames detected and with optimization of false positive (doff) rate with an exemplary eye blink detection classification component can provide reliable nominal use case detection, short latency of don 906 event, longer latency of doff 908 event, false positives of decision tree classifier ML model portion of the exemplary liveness classification algorithm having limited duration (due to eye blink detection), and rare false positives (don) rate that will not drain the battery of wearable devices configured as described herein.

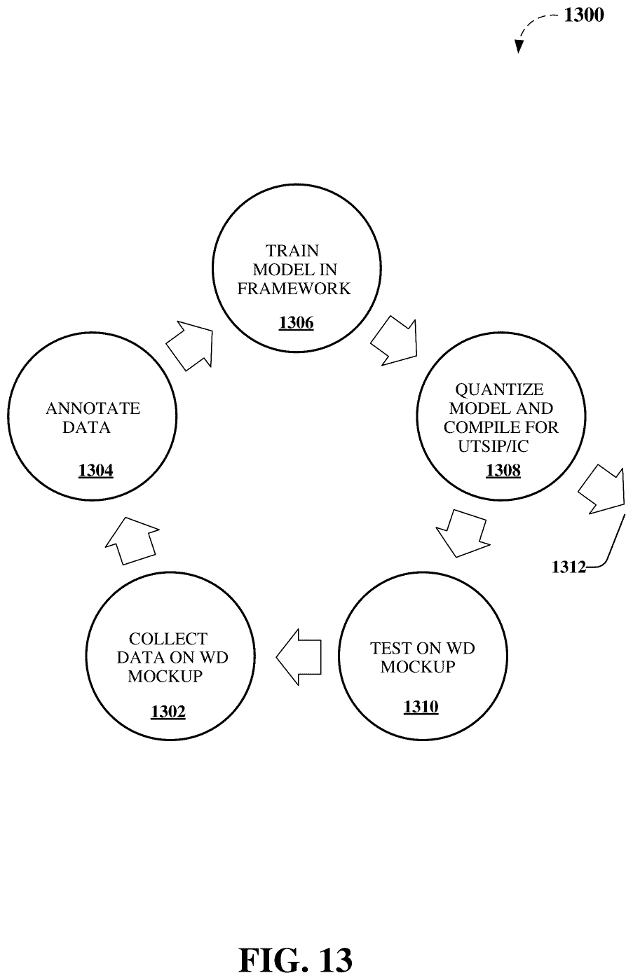

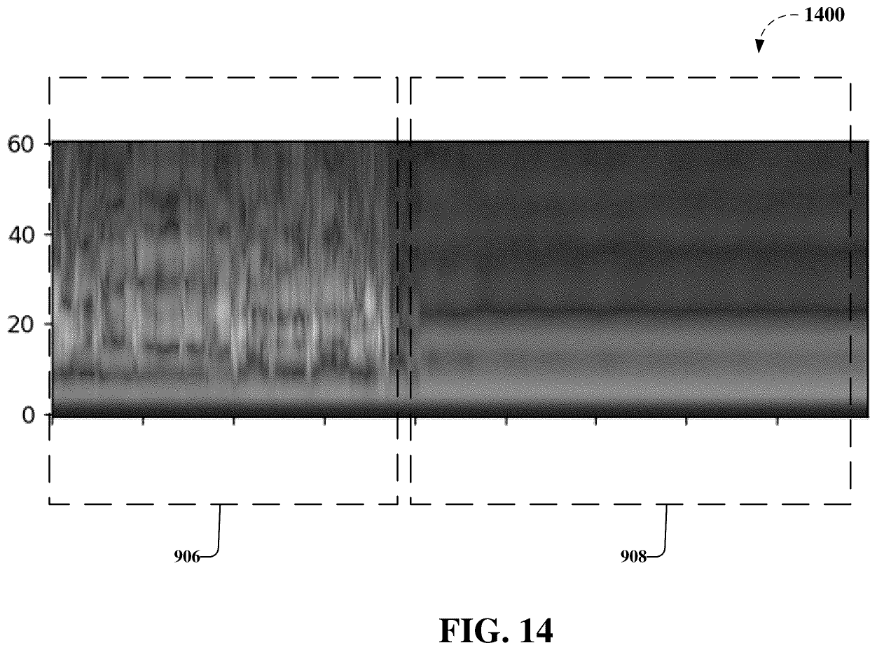

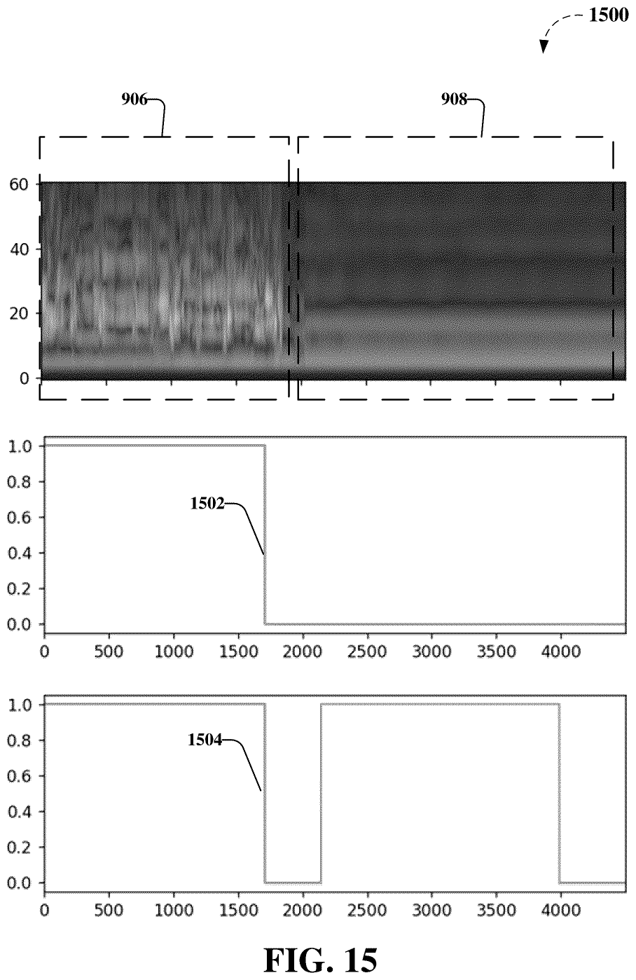

FIG. 13 illustrates a block diagram 1300 of a non-limiting training processes for an exemplary apparatus or device that facilitates liveness and/or proximity detection in accordance with one or more embodiments described herein. Thus, exemplary ML model training system 116 can comprise or be associated with a body of training data 118 such as can be collected by employing a test wearable device 1302, which can comprise ultrasonic transceiver observations (e.g., pulse-echo) as described below regarding FIG. 14. In addition, exemplary ML model training system 116 can facilitate data annotation or labeling at 1304, which data are labelled or annotated according to a desired output state (e.g., donned, doffed), for example, as further described herein regarding FIG. 15.

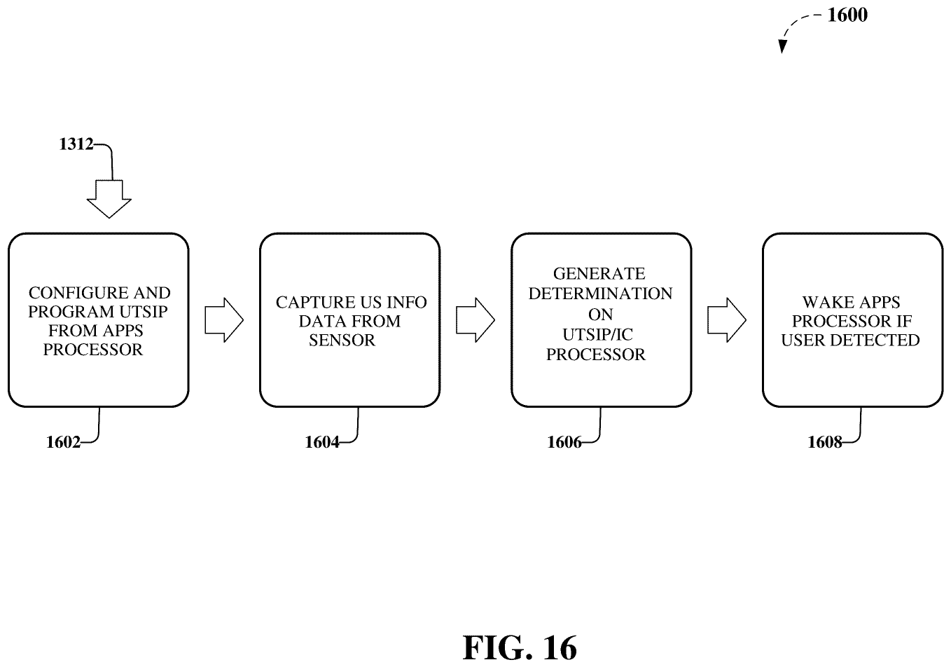

In further embodiments, exemplary ML framework 120 can facilitate ML model generation and training 1306, as further described herein regarding FIGS. 1-2. In a non-limiting aspect, exemplary ML model training system 116 can employ TensorFlow aa an exemplary ML framework 120 to develop and train exemplary ML model 122, for example, as further described herein. Thereafter, specific implementations of the exemplary ML model 122 can be compiled and propagated to specific hardware implementations such as exemplary UTSIP apparatus or device (e.g., exemplary UTSIP 102, exemplary IC 202 with ultrasonic transceiver 204, exemplary UTSIP apparatus or device 302), as further described herein, for example to produce an exemplary liveness detection classifier component 110, exemplary determination component 112, and the like that facilitate liveness and/or proximity detection in accordance with one or more embodiments described herein. In a further non-limiting aspect, the compiled and propagated exemplary ML model 122 can be tested or validated at 1310 once again on the test wearable device, data collected 1302, annotated 1304, the model further trained, and so on. Once the exemplary ML model 122 is accepted it can be compiled and propagated to specific hardware implementations such as exemplary UTSIP apparatus or device (e.g., exemplary UTSIP 102, exemplary IC 202 with ultrasonic transceiver 204, exemplary UTSIP apparatus or device 302), for end use, as further described herein regarding FIG. 16.

FIG. 14 depicts non-limiting aspects 1400 regarding a UTSIP apparatus or device signal that can facilitate liveness and/or proximity detection in accordance with one or more embodiments described herein. As with FIG. 6, FIG. 14 depicts a two-dimensional contour plot of the raw data of the transmitted pulses and received echoes over time, where the contour plot depicts a donned 906 test device that, after some time, is doffed 908, as further described herein. For instance, the test device can comprise an HMD with an ultrasonic transceiver (e.g., ultrasonic transceiver 104, 204, 304) aimed at a user's forehead when the test device is donned 906. As previously described, exemplary ultrasonic transceiver (e.g., ultrasonic transceiver 104, 204, 304) periodically sends an ultrasonic pulse and measures the echo, and one pulse correspond to one echo frame received, which is referred to herein as “A-scan” frames. In a non-limiting aspect regarding data collection 1302, a pulse rate of 50 Hz, is employed. It should be understood that such pulse rate could be substantially more or less. As a result, 50 A-scan frames are generated per second (x-axis), each of which is 61 samples long (e.g., 1 sample is about 2 mm), in the data collection 1302 example of FIG. 14, which translates to a distance (y-axis) of approximately 120 mm. Each column of the image in FIG. 14 is one A-scan frame of 61 samples, and of these 61 samples, 57 (indices 3:60) are employed as the input the exemplary ML model 122. In FIG. 14 higher ultrasound pressure is indicated by lighter coloration and lower ultrasound pressure is indicated by darker coloration.

FIG. 15 depicts further non-limiting aspects 1500 regarding a UTSIP apparatus or device signal that can facilitate liveness and/or proximity detection in accordance with one or more embodiments described herein. For instance, as further described above exemplary ML model training system 116 can facilitate data annotation or labeling at 1304, which data are labelled or annotated according to a desired output state (e.g., donned, doffed), for example. Thus, FIG. 15 repeats FIG. 14 two-dimensional contour plot of the raw data of the transmitted pulses and received echoes over time at the top, followed by the classification/annotation label 1502 of data, where 0 corresponds to a doff 908 condition and 1 corresponds to a don 906. At the bottom of FIG. 15 a weighting function or sample weight 1504 values can be employed, where 0 corresponds to a sample weight generated to ignore the classification/annotation label 1502, and where 1 corresponds to a sample weight generated to include the classification/annotation label 1502 in the loss function minimization in the ML model generation and training 1306. For instance, in non-limiting aspects, ML model generation and training 1306 can be configured to attempts to minimize a “loss function.” Thus, in a non-limiting aspect, sample weights 1504 can be used to cause the training to ignore certain regions that are unhelpful in the classification of liveness or proximity, such as transitional regions (those between don 906 and doff 908), as a non-limiting example.

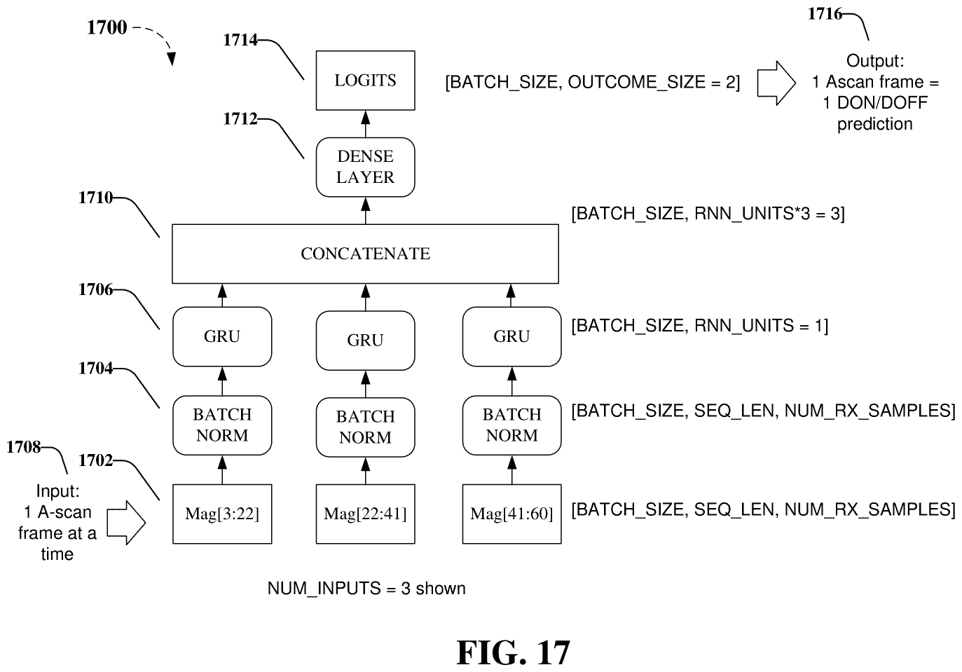

Accordingly, the pulse-echo data A-scan frames having the appropriate classification/annotation labels 1502 and sample weights 1504, exemplary ML model training system 116 can facilitate exemplary ML model 122 selection/generation, and training. As previously discussed, accurate don/doff state cannot be accurately predicted by looking at only the most recent A-scan frame. As a result, suitable ML model 122 can comprise a convolutional neural network (CNN) or a recursive neural network (RNN). Various embodiments described herein can facilitate liveness and/or proximity detection based on a RNN ML model 122. In a non-limiting aspect, an exemplary RNN ML model 122 can have a smaller memory footprint, suitable for low-power, integrated devices such as described above regarding FIGS. 1 and 3, for example. In further non-limiting aspects, it can be appreciated that an exemplary RNN ML model 122 does not need to store previous A-scan frames like a CNN ML model 122 would, which exemplary RNN ML model 122 instead uses the output of the exemplary RNN ML model 122 to feed back to the input. In a further non-limiting aspect, various embodiments described herein can facilitate liveness and/or proximity detection based on a gated-recurrent unit (GRU) RNN ML model 122, for example, as further described herein regarding FIGS. 16-17. Accordingly, exemplary ML model training system 116 can facilitate exemplary GRU RNN ML model 122 generation and training, as further described herein. Accordingly, FIG. 16 depicts a block diagram 1600 illustrating non-limiting aspects of exemplary apparatuses or devices that facilitate liveness and/or proximity detection in accordance with one or more embodiments described herein. For instance, FIG. 16 depicts application processes for an exemplary liveness classification algorithm including a ML model 122 (e.g., GRU RNN ML classifier model 1312) that can be compiled and propagated to an exemplary UTSIP apparatus or device (e.g., exemplary UTSIP 102, exemplary IC 202 with ultrasonic transceiver 204, exemplary UTSIP apparatus or device 302) (e.g., programmed and configured 1602), such as via a host processor (not shown) device comprising exemplary UTSIP apparatus or device, an application processor (not shown) device comprising exemplary UTSIP apparatus or device, and so on, as further described herein regarding FIGS. 1-3 and 13. Thus, at run time, ultrasonic information such as provided by (e.g., exemplary UTSIP 102, exemplary IC 202 with ultrasonic transceiver 204, exemplary UTSIP apparatus or device 302) can be captured at 1604. According to various embodiments, exemplary liveness classification algorithm comprising a ML model 122 (e.g., ML classifier model 1312) based on a liveness detection classifier recursive neural network (e.g., GRU RNN ML model 122) trained on captured and classified ultrasonic information, for example, as described above regarding FIGS. 14 and 15, which ultrasonic information is received 1302 during a set of states of use of a test wearable device (e.g., WD mockup). As further described herein regarding FIGS. 1-2, for example, an exemplary liveness detection classifier component 110 can be configured to generate the classification of the ultrasonic information as indicative of the proximity or the liveness based on the liveness classification algorithm. Based on a determination at 1606 of proximity or the liveness as a result of the liveness classification algorithm, exemplary power management component 114 can be configured as described herein to select a power state or an operating mode of the wearable device based the determination (e.g., via exemplary determination component 112) of the proximity and/or liveness of the user of the wearable device, for example, as further described herein regarding FIGS. 1-2. For instance, at 1608, exemplary power management component 114 can be configured to wake an apps processor (not shown) of a device comprising exemplary UTSIP apparatus or device, can be configured to wake a host processor (not shown) of a device comprising exemplary UTSIP apparatus or device, and so on.

FIG. 17 depicts a block diagram 1700 illustrating further non-limiting aspects of exemplary apparatuses or devices that facilitate liveness and/or proximity detection in accordance with one or more embodiments described herein. For instance, FIG. 17 depicts an exemplary liveness detection classifier recursive neural network (e.g., GRU RNN ML model 122) trained on captured and classified ultrasonic information, for example, as described above regarding FIGS. 14 and 15.

In a non-limiting aspect, FIG. 17 depicts an exemplary liveness detection classifier recursive neural network (e.g., GRU RNN ML model 122) as a combination of neural networks, wherein each progression of mag 1702 (which capture sample magnitude), batch normalization 1704 (e.g., batch normalization of the data so that it's scaled appropriately for GRU 1706), and GRU 1706 (having only 1 output, 1 state) can be described as operating like three independent neural networks at the bottom of FIG. 17, where ultrasonic information flowing in gets split into three channels (NUM_INPUTS=3) by sample index. Thus, captured pulse-echo ultrasonic information is input 1708, one A-scan frame at a time, split up into three segments of 19 samples each, discarding initial samples of pulse-echo ultrasonic information.

In a further non-limiting aspect, GRU 1706 comprise a recursive layer (having memory, which enables decision-making based on the past samples), which then the outputs of three GRU 1706 are combined at concatenate 1710, and passed to another simple neural network comprising dense layer 1712, which provides a linear combination of the inputs, which in this will produce two outputs (e.g., only two possible states at the output, don 906, doff 908). The output of the dense layer 1712 is passed to logits 1714, which generates log of probability, where large positive numbers indicate a highly likely condition (e.g., don 906 or doff 908), and where large negative numbers indicate a very unlikely condition (e.g., don 906 or doff 908), resulting in two outputs, one of which indicates likelihood of don 906 and the other of which indicates likelihood of doff 908, to facilitate generation of the final classification prediction output 1716 of liveness and/or proximity detection in accordance with one or more embodiments described herein. Note that in the instance where both logits 1714 outputs indicate of very unlikely condition, the classification would result in neither a don 906 nor doff 908 condition.

Accordingly, various embodiments described herein can comprise a ML model 122 based on a liveness detection classifier recursive neural network RNN) trained 1306 on captured 1302 and the classified/labeled 1304 ultrasonic information received during a of states of use of a test wearable device (e.g., HMD mockup), for example, as further described herein regarding FIGS. 14-15. As a non-limiting example, an exemplary liveness detection classifier RNN can comprise GRU RNN trained 1306 on captured 1302 and the classified/labeled 1304 ultrasonic information received during the set of states of use of the test wearable device (e.g., HMD mockup), for example, as further described herein regarding FIGS. 14-15. In a non-limiting aspect, an exemplary GRU RNN, as described herein, for a plurality of measurement vectors associated with the ultrasonic information, is configured to generate a classification prediction output 1716 of the donned 906 or the doffed 908 state of the wearable device. In a further non-limiting aspect, exemplary classification prediction output 1716 of the donned 906 or the doffed 908 state of the wearable device is based on the proximity or liveness of the user of the wearable device. In still further non-limiting aspects, exemplary classification prediction output 1716 of the donned 906 or the doffed 908 state of the wearable device is based on the liveness of the user of the wearable device, which is based on detection of an eye movement, an eye blink, a facial movement, or a facial expression change in one or more echo of the echoes in the ultrasonic information as processed by the GRU RNN.

Accordingly, various embodiments described herein, an exemplary ML model training system 116 can be employed to produce an exemplary ML model 122 for the classification of ultrasonic information as indicative of proximity or liveness of a user of a wearable device (or a device in use) based on a TensorFlow ML framework 120, which exemplary ML model 122 (e.g., GRU RNN ML classifier model 1312) can trained 1306 on a database collected using an test device (e.g., HMD mockup) comprising exemplary UTSIP apparatus or device (e.g., exemplary UTSIP 102, exemplary IC 202 with ultrasonic transceiver 204, exemplary UTSIP apparatus or device 302). In a non-limiting aspect, an exemplary GRU RNN ML classifier model 1312 can be quantized to int32 using TensorFlow ML framework 120 and manually modified and optimized into int16 format for use on a 16-bit MCU such as can be employed in exemplary UTSIP apparatus or device (e.g., exemplary UTSIP 102, exemplary IC 202 with ultrasonic transceiver 204, exemplary UTSIP apparatus or device 302). According to non-limiting aspects, an exemplary 16-bit integer GRU RNN ML classifier model 1312 approaches similar model accuracy as a 32-bit integer GRU RNN ML classifier model 1312 or a floating point GRU RNN ML classifier model 1312.

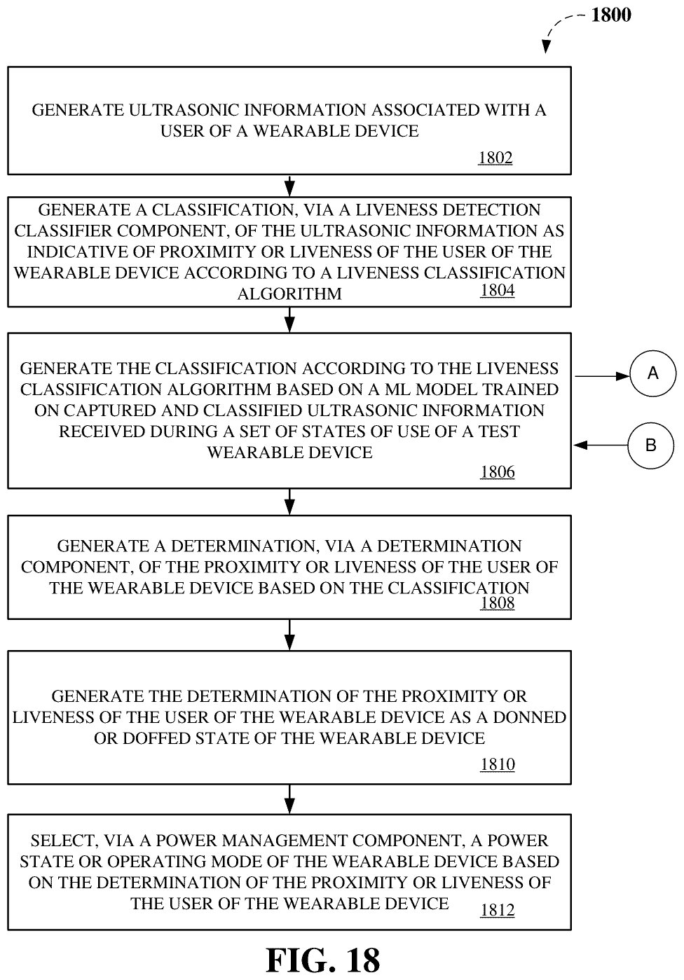

In view of the subject matter described supra, methods that can be implemented in accordance with the subject disclosure will be better appreciated with reference to the flowcharts of FIGS. 18-20. While for purposes of simplicity of explanation, the methods are shown and described as a series of blocks, it is to be understood and appreciated that such illustrations or corresponding descriptions are not limited by the order of the blocks, as some blocks may occur in different orders and/or concurrently with other blocks from what is depicted and described herein. Any non-sequential, or branched, flow illustrated via a flowchart should be understood to indicate that various other branches, flow paths, and orders of the blocks, can be implemented which achieve the same or a similar result. Moreover, not all illustrated blocks may be required to implement the methods described hereinafter.

### Exemplary Methods

FIG. 18 illustrates a non-limiting flow diagram of exemplary methods 1800 that facilitate liveness and/or proximity detection in accordance with one or more embodiments described herein. In non-limiting embodiments, exemplary methods 1800 can comprise, at 1802, generating, by an ultrasonic transceiver (e.g., ultrasonic transceiver 104/204/304) operatively coupled to a processor (e.g., processor 108, MCU 312), ultrasonic information associated with a user of a wearable device (e.g., wearable device or other battery powered device), as further described herein regarding FIGS. 1-4, 8-17, for example. In a non-limiting aspect generating ultrasonic information associated with the user of the wearable device (e.g., wearable device or other battery powered device) can comprise generating ultrasonic time of flight range information.

In another non-limiting embodiment, exemplary methods 1800 can comprise, at 1804, generating a classification, via a liveness detection classifier component (e.g., liveness detection classifier component 110) associated with a memory (e.g., memory 106, program memory 314) coupled to the processor (e.g., processor 108, MCU 312), of the ultrasonic information as indicative of one of proximity or liveness of the user of the wearable device (e.g., wearable device or other battery powered device) according to a liveness classification algorithm executed by the processor (e.g., processor 108, MCU 312), as further described herein regarding FIGS. 1-4, 8-17, for example. In a non-limiting aspect, generating the ultrasonic information can comprise emitting ultrasonic pulses and receiving echoes as the ultrasonic information, and wherein the generating the classification according to the liveness classification algorithm can comprise analyzing expected echoes of the user and determining whether the wearable device (e.g., wearable device or other battery powered device) is being worn by the user. In another non-limiting aspect, generating the classification, via the liveness detection classifier component (e.g., liveness detection classifier component 110), of the ultrasonic information as indicative of the proximity or the liveness can be based on the ultrasonic transceiver (e.g., ultrasonic transceiver 104/204/304) being positioned within the wearable device (e.g., wearable device or other battery powered device) such that the field of view of the ultrasonic transceiver (e.g., ultrasonic transceiver 104/204/304) will cover a body part of the user that experiences movement relative to the ultrasonic transceiver (e.g., ultrasonic transceiver 104/204/304) when the wearable device (e.g., wearable device or other battery powered device) is being worn by the user.

In further non-limiting embodiments, exemplary methods 1800 can comprise, at 1806, generating the classification according to the liveness classification algorithm based on a machine learning model (e.g., machine learning model 122, 808, 1312) trained on captured and classified ultrasonic information received during a set of states of use of a test wearable device (e.g., wearable device or other battery powered device), as further described herein regarding FIGS. 1-4, 8-17, for example. As a non-limiting aspect, generating the classification according to the liveness classification algorithm based on a machine learning model (e.g., machine learning model 122, 808, 1312) can comprise generating the classification according to the liveness classification algorithm based on a machine learning model machine learning model involving a liveness detection classifier decision tree, as described above regarding FIGS. 8-12 and 19, or based on a machine learning model involving a liveness detection classifier RNN or GRU RNN, as described above regarding FIGS. 13-17 and 20, and as depicted in FIG. 17.

In still further non-limiting embodiments, exemplary methods 1800 can comprise, at 1808, generating a determination, via a determination component (e.g., determination component 112) associated with the memory (e.g., memory 106, program memory 314), of the proximity or the liveness of the user of the wearable device (e.g., wearable device or other battery powered device) based on the classification, as further described herein regarding FIGS. 1-4, 8-17, for example. In a non-limiting aspect, generating the determination of liveness can comprise generating the determination of liveness based on one of the proximity or a change in the proximity, a physiological event detection, a predetermined time delay, or a predetermined classification cycle delay. In another non-limiting aspect, generating the determination of liveness can comprise generating the determination of liveness based on the physiological event detection comprising one of a pulse rate detection, a circulatory flow detection, a respiratory event detection, an eye movement detection, an eye blink detection, a facial movement detection, or a facial expression change detection.

In addition, further embodiments of exemplary methods 1800 can comprise, at 1810, generating the determination of the proximity or the liveness of the user of the wearable device (e.g., wearable device or other battery powered device) as a donned 906 or doffed 908 state of the wearable device (e.g., wearable device or other battery powered device), as further described herein regarding FIGS. 1-4, 8-17, for example.

In other non-limiting embodiments, exemplary methods 1800 can comprise, at 1812, selecting, via a power management component (e.g., power management component 114) associated with the memory (e.g., memory 106, program memory 314), one of a power state or operating mode of the wearable device (e.g., wearable device or other battery powered device) based on the determination of the proximity or the liveness of the user of the wearable device (e.g., wearable device or other battery powered device), as further described herein regarding FIGS. 1-4, 8-17, for example.

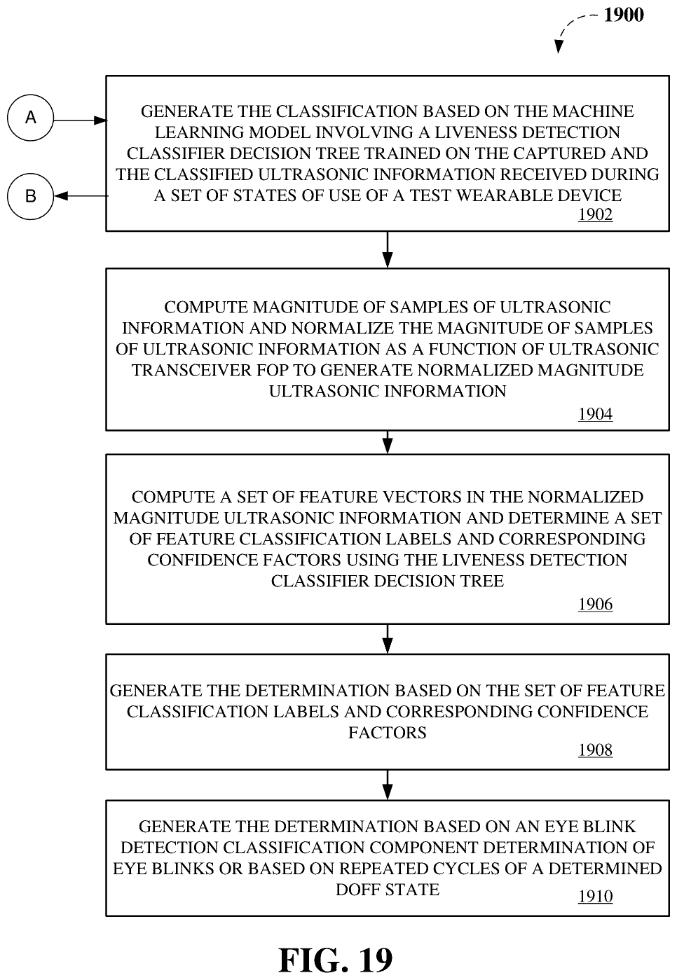

FIG. 19 illustrates another non-limiting flow diagram of exemplary methods 1900 that facilitate liveness and/or proximity detection in accordance with one or more embodiments described herein. In non-limiting embodiments, exemplary methods 1900 can comprise, at 1902, generating the classification according to the liveness classification algorithm based on the machine learning model (e.g., machine learning model 122, 808, 1312) can comprise generating the classification based on the machine learning model (e.g., machine learning model 122, 808) involving a liveness detection classifier decision tree trained on the captured and the classified ultrasonic information received during the set of states of use of the test wearable device (e.g., wearable device or other battery powered device), as further described herein regarding FIGS. 1-4, 8-12, for example.

In further non-limiting embodiments, exemplary methods 1900 can comprise, at 1904, generating the classification, via the liveness detection classifier component (e.g., liveness detection classifier component 110) configured to generate the classification of the ultrasonic information as indicative of the proximity or the liveness based on the liveness classification algorithm, including computing magnitude of samples of ultrasonic information and normalizing the magnitude of samples of ultrasonic information as a function of ultrasonic transceiver (e.g., ultrasonic transceiver 104/204/304) operating frequency (Fop) to generate normalized magnitude ultrasonic information), as further described herein regarding FIGS. 1-4, 8-12, for example.

In other non-limiting embodiments, exemplary methods 1900 can comprise, at 1906, generating the classification, via the liveness detection classifier component (e.g., liveness detection classifier component 110) configured to generate the classification of the ultrasonic information as indicative of the proximity or the liveness based on the liveness classification algorithm, including computing a set of feature vectors in the normalized magnitude ultrasonic information and determining a set of feature classification labels and corresponding confidence factors using the liveness detection classifier decision tree, as further described herein regarding FIGS. 1-4, 8-12, for example.

In addition, other non-limiting embodiments, exemplary methods 1900 can comprise, at 1908, generating the determination via the determination component (e.g., determination component 112) configured to generate the determination of the proximity or the liveness based on the set of feature classification labels and corresponding confidence factors, as further described herein regarding FIGS. 1-4, 8-12, for example.

In still other non-limiting embodiments, exemplary methods 1900 can comprise, at 1910, generating the determination via the determination component (e.g., determination component 112) configured to generate the determination of the proximity or the liveness of the user of the wearable device (e.g., wearable device or other battery powered device) as the donned 906 or the doffed 908 state of the wearable device (e.g., wearable device or other battery powered device), based on one of an eye blink detection classification component (not shown) determination of a set of eye blinks or repeated cycles of a determined doff 908 state, as further described herein regarding FIGS. 1-4, 8-12, for example.

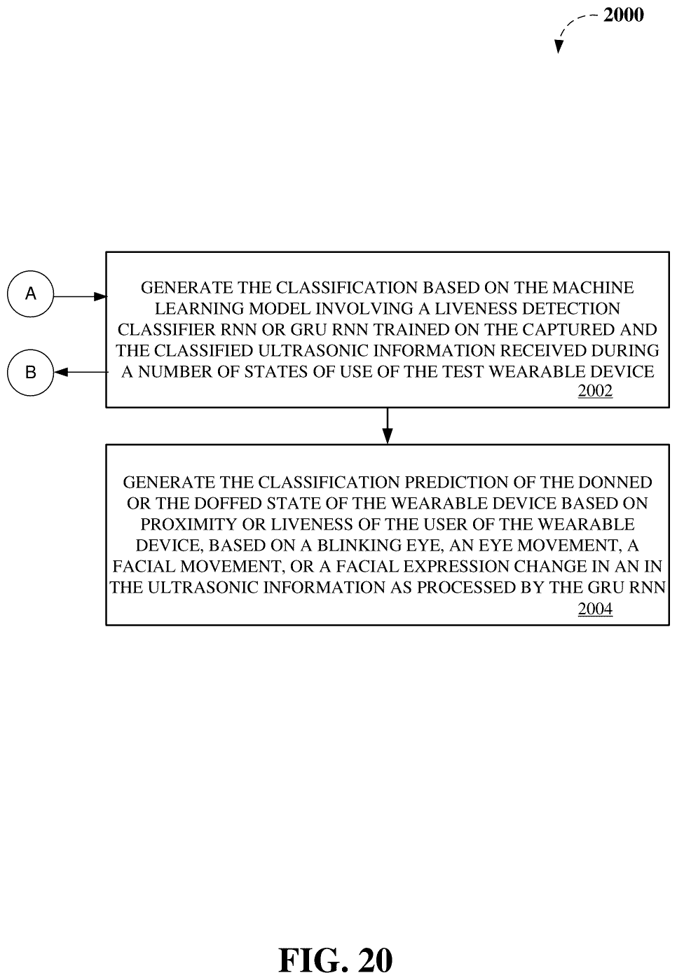

FIG. 20 illustrates another non-limiting flow diagram of exemplary methods that facilitates liveness and/or proximity detection in accordance with one or more embodiments described herein. In non-limiting embodiments, exemplary methods 2000 can comprise, at 2002, generating the classification based on the machine learning model (e.g., machine learning model 122, 1312) involving a liveness detection classifier RNN trained on the captured and the classified ultrasonic information received during the set of states of use of the test wearable device (e.g., wearable device or other battery powered device), as further described herein regarding FIGS. 1-4, 13-17, for example. In a non-limiting aspect, generating the classification based on the machine learning model (e.g., machine learning model 122, 1312) involving the liveness detection classifier RNN can comprise generating the classification based on the machine learning model (e.g., machine learning model 122, 1312) involving a GRU (e.g., GRU RNN ML model 122) trained on the captured and the classified ultrasonic information received during the set of states of use of the test wearable device (e.g., wearable device or other battery powered device). In a further non-limiting aspect, generating the classification based on the machine learning model (e.g., machine learning model 122, 1312) involving the GRU (e.g., GRU RNN ML model 122) can comprise, for a number of measurement vectors associated with the ultrasonic information, generating a classification prediction of the donned 906 or the doffed 908 state of the wearable device (e.g., wearable device or other battery powered device). In addition, generating the classification prediction of the donned 906 or the doffed 908 state of the wearable device (e.g., wearable device or other battery powered device) can comprise generating the classification prediction of the donned 906 or the doffed 908 state of the wearable device (e.g., wearable device or other battery powered device) based on the one of the proximity or the liveness of the user of the wearable device (e.g., wearable device or other battery powered device), in other non-limiting aspects.

In other non-limiting embodiments, exemplary methods 2000 can comprise, at 2004, generating the classification prediction of the donned 906 or the doffed 908 state of the wearable device (e.g., wearable device or other battery powered device) based on the one of the proximity or the liveness of the user of the wearable device (e.g., wearable device or other battery powered device), which is based on one of a blinking eye, a facial movement, or a facial expression change in an echo of the echoes in the ultrasonic information as processed by the GRU (e.g., GRU RNN ML model 122), as further described herein regarding FIGS. 1-4, 13-17, for example.

### Exemplary Computing Environment

Various embodiments described herein can comprise or be associated with a computer-implemented system for creating and training of machine learning models for employment in devices or apparatuses that facilitate proximity and/or liveness detection.

Those having ordinary skill in the art will appreciate that the herein disclosure describes non-limiting examples of various embodiments of the invention. For case of description and/or explanation, various portions of the herein disclosure utilize the term “each” when discussing various embodiments of the invention. Those having ordinary skill in the art will appreciate that such usages of the term “each” are non-limiting examples. In other words, when the herein disclosure provides a description that is applied to “each” of some particular computerized object and/or component, it should be understood that this is a non-limiting example of various embodiments of the invention, and it should be further understood that, in various other embodiments of the invention, it can be the case that such description applies to fewer than “each” of that particular computerized object.

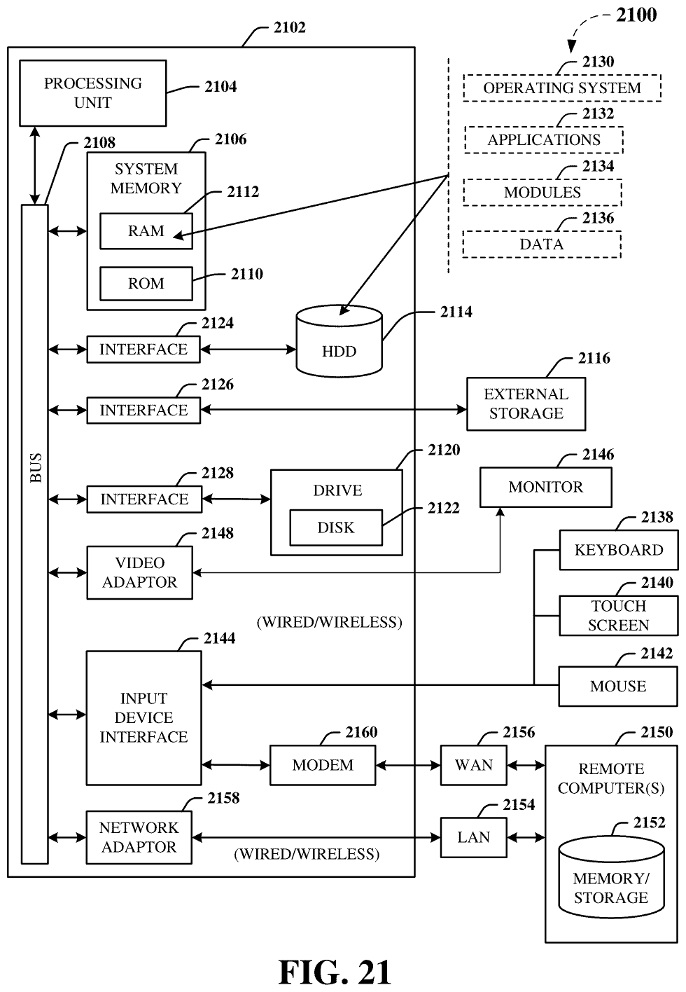

FIG. 21 illustrates a block diagram 2100 of an example, non-limiting operating environment in which one or more embodiments described herein can be facilitated. In order to provide additional context for various embodiments described herein, FIG. 21 and the following discussion are intended to provide a brief, general description of a suitable computing environment 2100 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 21, the example environment 2100 for implementing various embodiments of the aspects described herein includes a computer 2102, the computer 2102 including a processing unit 2104, a system memory 2106 and a system bus 2108. The system bus 2108 couples system components including, but not limited to, the system memory 2106 to the processing unit 2104. The processing unit 2104 can be any of various commercially available processors. Dual microprocessors and other multi processor architectures can also be employed as the processing unit 2104.

The system bus 2108 can be any of several types of bus structure that can further interconnect to a memory bus (with or without a memory controller), a peripheral bus, and a local bus using any of a variety of commercially available bus architectures. The system memory 2106 includes ROM 2110 and RAM 2112. A basic input/output system (BIOS) can be stored in a non-volatile memory such as ROM, erasable programmable read only memory (EPROM), EEPROM, which BIOS contains the basic routines that help to transfer information between elements within the computer 2102, such as during startup. The RAM 2112 can also include a high-speed RAM such as static RAM for caching data.

The computer 2102 further includes an internal hard disk drive (HDD) 2114 (e.g., EIDE, SATA), one or more external storage devices 2116 (e.g., a magnetic floppy disk drive (FDD) 2116, a memory stick or flash drive reader, a memory card reader, etc.) and a drive 2120, e.g., such as a solid state drive, an optical disk drive, which can read or write from a disk 2122, such as a CD-ROM disc, a DVD, a BD, etc. Alternatively, where a solid-state drive is involved, disk 2122 would not be included, unless separate. While the internal HDD 2114 is illustrated as located within the computer 2102, the internal HDD 2114 can also be configured for external use in a suitable chassis (not shown). Additionally, while not shown in environment 2100, a solid-state drive (SSD) could be used in addition to, or in place of, an HDD 2114. The HDD 2114, external storage device(s) 2116 and drive 2120 can be connected to the system bus 2108 by an HDD interface 2124, an external storage interface 2126 and a drive interface 2128, respectively. The interface 2124 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 2102, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 2112, including an operating system 2130, one or more application programs 2132, other program modules 2134 and program data 2136. All or portions of the operating system, applications, modules, and/or data can also be cached in the RAM 2112. The systems and methods described herein can be implemented utilizing various commercially available operating systems or combinations of operating systems.

Computer 2102 can optionally comprise emulation technologies. For example, a hypervisor (not shown) or other intermediary can emulate a hardware environment for operating system 2130, and the emulated hardware can optionally be different from the hardware illustrated in FIG. 21. In such an embodiment, operating system 2130 can comprise one virtual machine (VM) of multiple VMs hosted at computer 2102. Furthermore, operating system 2130 can provide runtime environments, such as the Java runtime environment or the .NET framework, for applications 2132. Runtime environments are consistent execution environments that allow applications 2132 to run on any operating system that includes the runtime environment. Similarly, operating system 2130 can support containers, and applications 2132 can be in the form of containers, which are lightweight, standalone, executable packages of software that include, e.g., code, runtime, system tools, system libraries and settings for an application.

Further, computer 2102 can be enable with a security module, such as a trusted processing module (TPM). For instance, with a TPM, boot components hash next in time boot components and wait for a match of results to secured values, before loading a next boot component. This process can take place at any layer in the code execution stack of computer 2102, e.g., applied at the application execution level or at the operating system (OS) kernel level, thereby enabling security at any level of code execution.

A user can enter commands and information into the computer 2102 through one or more wired/wireless input devices, e.g., a keyboard 2138, a touch screen 2140, and a pointing device, such as a mouse 2142. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 2104 through an input device interface 2144 that can be coupled to the system bus 2108, but can be connected by other interfaces, such as a parallel port, an IEEE 1394 serial port, a game port, a USB port, an IR interface, a BLUETOOTH® interface, etc.

A monitor 2146 or other type of display device can be also connected to the system bus 2108 via an interface, such as a video adapter 2148. In addition to the monitor 2146, a computer typically includes other peripheral output devices (not shown), such as speakers, printers, etc.

The computer 2102 can operate in a networked environment using logical connections via wired and/or wireless communications to one or more remote computers, such as a remote computer(s) 2150. The remote computer(s) 2150 can be a workstation, a server computer, a router, a personal computer, portable computer, microprocessor-based entertainment appliance, a peer device or other common network node, and typically includes many or all of the elements described relative to the computer 2102, although, for purposes of brevity, only a memory/storage device 2152 is illustrated. The logical connections depicted include wired/wireless connectivity to a local area network (LAN) 2154 and/or larger networks, e.g., a wide area network (WAN) 2156. Such LAN and WAN networking environments are commonplace in offices and companies, and facilitate enterprise-wide computer networks, such as intranets, all of which can connect to a global communications network, e.g., the Internet.

When used in a LAN networking environment, the computer 2102 can be connected to the local network 2154 through a wired and/or wireless communication network interface or adapter 2158. The adapter 2158 can facilitate wired or wireless communication to the LAN 2154, which can also include a wireless access point (AP) disposed thereon for communicating with the adapter 2158 in a wireless mode.

When used in a WAN networking environment, the computer 2102 can include a modem 2160 or can be connected to a communications server on the WAN 2156 via other means for establishing communications over the WAN 2156, such as by way of the Internet. The modem 2160, which can be internal or external and a wired or wireless device, can be connected to the system bus 2108 via the input device interface 2144. In a networked environment, program modules depicted relative to the computer 2102 or portions thereof, can be stored in the remote memory/storage device 2152. It will be appreciated that the network connections shown are example and other means of establishing a communications link between the computers can be used.

When used in either a LAN or WAN networking environment, the computer 2102 can access cloud storage systems or other network-based storage systems in addition to, or in place of, external storage devices 2116 as described above, such as but not limited to a network virtual machine providing one or more aspects of storage or processing of information. Generally, a connection between the computer 2102 and a cloud storage system can be established over a LAN 2154 or WAN 2156 e.g., by the adapter 2158 or modem 2160, respectively. Upon connecting the computer 2102 to an associated cloud storage system, the external storage interface 2126 can, with the aid of the adapter 2158 and/or modem 2160, manage storage provided by the cloud storage system as it would other types of external storage. For instance, the external storage interface 2126 can be configured to provide access to cloud storage sources as if those sources were physically connected to the computer 2102.

The computer 2102 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

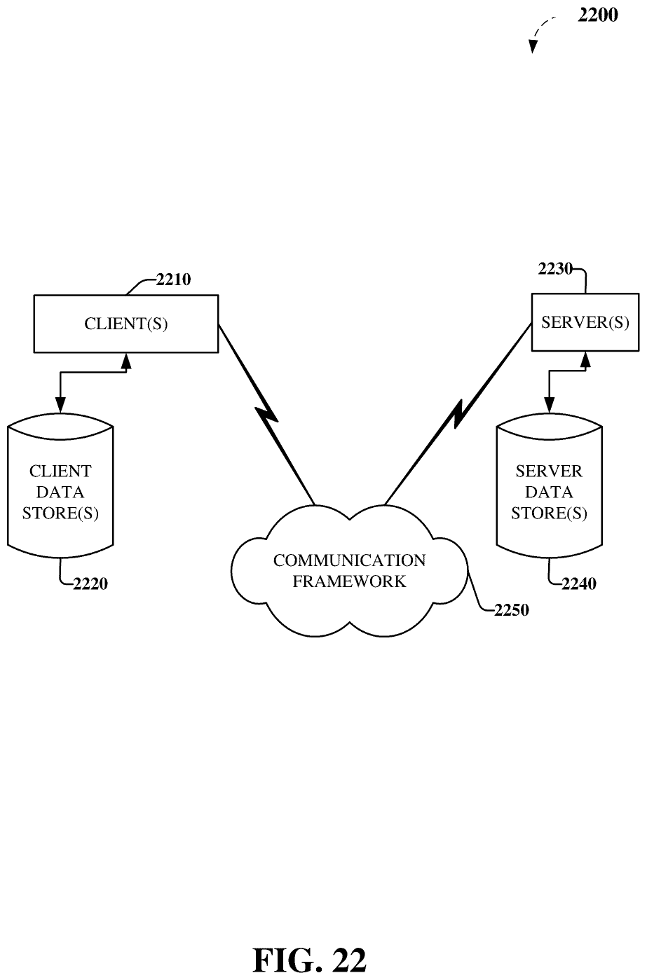

FIG. 22 illustrates a sample computing environment 2200 operable to execute various implementations described herein. The sample computing environment 2200 includes one or more client(s) 2210. The client(s) 2210 can be hardware and/or software (e.g., threads, processes, computing devices). The sample computing environment 2200 also includes one or more server(s) 2230. The server(s) 2230 can also be hardware and/or software (e.g., threads, processes, computing devices). The servers 2230 can house threads to perform transformations by employing one or more embodiments as described herein, for example. One possible communication between a client 2210 and a server 2230 can be in the form of a data packet adapted to be transmitted between two or more computer processes. The sample computing environment 2200 includes a communication framework 2250 that can be employed to facilitate communications between the client(s) 2210 and the server(s) 2230. The client(s) 2210 are operably connected to one or more client data store(s) 2220 that can be employed to store information local to the client(s) 2210. Similarly, the server(s) 2230 are operably connected to one or more server data store(s) 2240 that can be employed to store information local to the servers 2230.

The present invention may be a system, a method, an apparatus and/or a computer program product at any possible technical detail level of integration. The computer program product can include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer and/or computers, those skilled in the art will recognize that this disclosure also can or can be implemented in combination with other program modules. Generally, program modules include routines, programs, components, data structures, etc. that perform particular tasks and/or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments in which tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random-access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

### Further Embodiments

As described above, when using wearable computing devices such as augmented reality (AR) glasses, virtual reality (VR) headsets, or head mounted displays (HMDs) and the like, depending on the application, the program employing the wearable computing device can require user interaction, such as asking for an action confirmation, turning on/off wearable computing device, starting or stopping and application such as a game, navigating menus, and so on. Conventionally, users of such wearable computing devices are required to either press a button on the headset or on an external remote, manipulate a mouse, keyboard, or other input device such as a touchpad, and/or issue commands by voice control. Voice control can have several inconveniences related to privacy, noisy environments, and multi-user voice training, among other potential problems, whereas manipulating an input device with vision obscured and/or user hands otherwise occupied can be an unwanted distraction such as in an augmented or virtual reality environment.

Various non-limiting embodiments can employ eye blink detection and/or classification to facilitate, among other things, user control of a wearable computing device and/or its associated applications, processors, systems such as host systems, via novel applications of machine learning algorithms, as described herein. As non-limiting examples, user interaction can be facilitated with wearable computing devices such as augmented reality (AR) glasses, virtual reality (VR) headsets, or head mounted displays (HMDs) and the like without requiring any additional remote or other input device, as a user independent method of user interface (UI) control of associated applications, processors, systems such as host systems, via novel applications of machine learning algorithms, as described herein. In non-limiting aspects, automatic detection and/or classification of eye blink events such as an involuntary eye blink, voluntary eye blink, long (or held) eye blink, double eye blink, triple eye blink, right eye wink, left eye wink, a predetermined set (or number) of eye blinks, or a predetermined blinking pattern (e.g., combinations of long, short, left, right), and so on can facilitate UI control of associated applications, processors, systems such as host systems, via novel applications of machine learning algorithm as described herein. Accordingly, various non-limiting embodiments can employ an ultrasonic transceiver (e.g., exemplary ultrasonic transceiver system in package (UTSIP) apparatus or device) to facilitate eye blink detection and/or classification for easy integration of low power detection and/or classification algorithms to enable an improved user experience of wearable computing devices, which can be user and environment independent (e.g., robust to user differences, noise, lighting, users wearing glasses). Ultrasonic eye blink detection and/or classification as described herein can offer improved power consumption over other potential methods of eye blink detection and/or classification such as a camera mounted inside the wearable computing device, which can suffer from high power consumption, difficult lighting conditions, as well as create potential privacy concerns. While laser-based eye blink detection might be possible, safety concerns mitigate against realistic laser-based eye blink detection implementations.

Various embodiments described herein can employ a device mounted ultrasonic transceiver configured for close range sensing. In non-limiting aspects, exemplary device mounted ultrasonic transceiver can be placed position in HMD and/or the like with the ultrasonic transceiver pointing towards the user's head and configured to analyzes the ultrasonic transceiver signal for automatic detection and/or classification of anticipated types of eye blink, while discriminating against other wearable device events such as non-blinking, HMD and the like not in use, etc. In non-limiting aspects, for example, various embodiments of exemplary wearable devices can employ an ultrasonic transceiver inside a wearable device such as an HMD or the like, pointing towards the user's face, with the ultrasonic transceiver configured to a sensing range from about 0 centimeters (cm) to about 20 cm. In other non-limiting aspects, sampling rates of about 25 frames/second(s) or more can facilitate reliable detection of eye blink motion, understanding that expected duration of a typical eye blink can be between 100 and 400 milliseconds (ms), and low detection and/or classification latency to yield workable implementations. It should be understood that such implementation details are provided as an aid to understanding and to making and using the various embodiments provided herein, and as such, they should not be construed as a limitation of the claims appended herein.

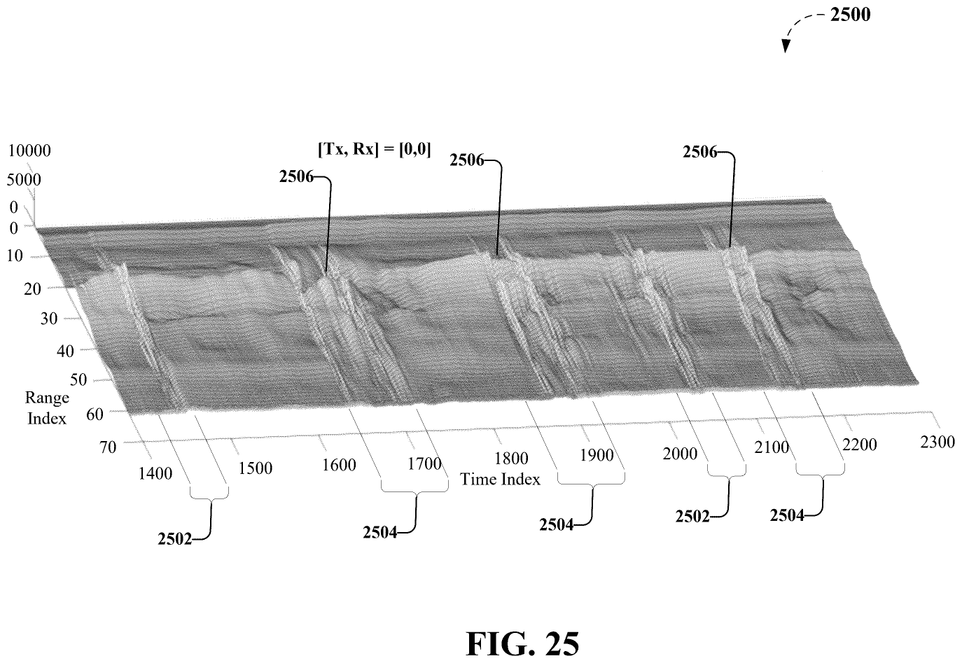

Thus, in various disclosed embodiments, the employed ultrasonic transceiver can emit an ultrasonic pulse and can detect reflected echoes, which amplitude can be sampled to create an ultrasonic magnitude profile, where each value of the profile corresponds to a particular distance from the sensor, for example, as depicted below regarding FIGS. 25-28. As further described herein, various eye blinks and patterns thereof can be clearly distinguished from periods without eye blink (as well as from other eye blinks and/or patterns thereof) by analyzing the ultrasonic magnitude profile. As a result, various embodiments can employ eye blink detection classifier using machine learning trained to automatically detect and classify different types of eye blinks and/or sets or patterns thereof to facilitate UI control of the wearable device associated applications, processors, systems such as host systems, and so on via the novel applications of machine learning algorithms as described herein.

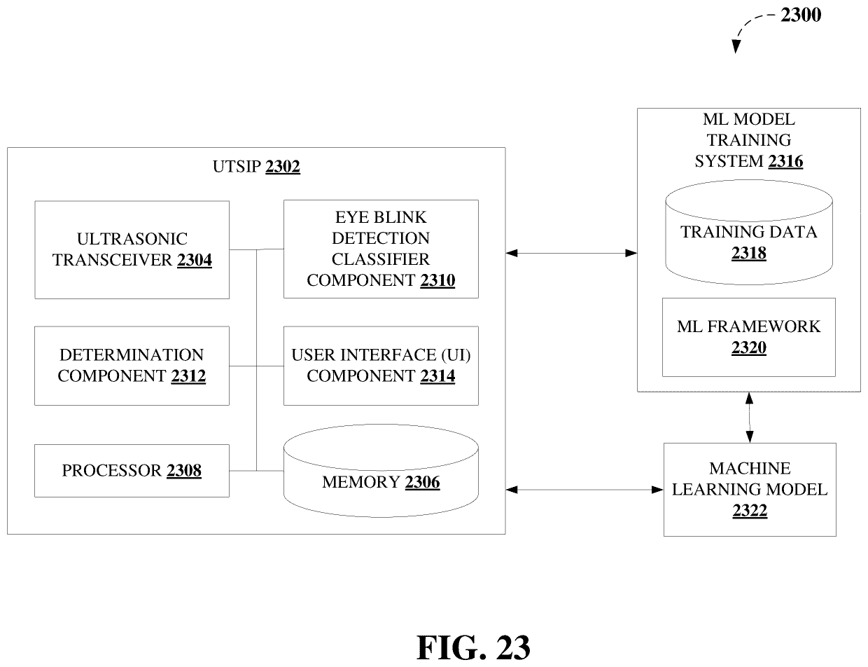

FIG. 23 illustrates a block diagram 2300 of an exemplary, non-limiting apparatus or device that facilitates eye blink detection and/or classification in accordance with one or more embodiments described herein. For instance, an exemplary, non-limiting apparatus or device can comprise a UTSIP 2302 that facilitates eye blink detection and/or classification in accordance with one or more embodiments described herein. In a nonlimiting aspect, exemplary UTSIP 2302 can comprise or be associated with an ultrasonic transceiver 2304, such as an ultrasonic ToF transceiver that facilitates eye blink detection and/or classification in accordance with one or more embodiments described herein.

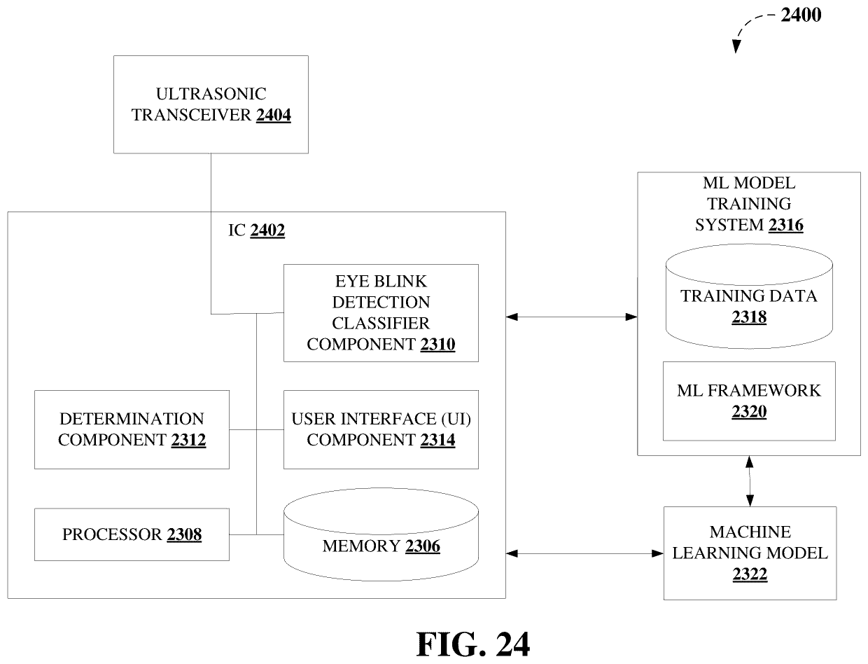

FIG. 24 illustrates another block diagram 2400 of an exemplary, non-limiting apparatus or device that facilitates eye blink detection and/or classification in accordance with one or more embodiments described herein. As an example, an exemplary, non-limiting apparatus or device can comprise an IC 2402 that facilitates eye blink detection and/or classification in accordance with one or more embodiments described herein. In a nonlimiting aspect, exemplary IC 2402 can comprise or be associated with an ultrasonic transceiver 2404, such as an ultrasonic ToF transceiver that facilitates eye blink detection and/or classification in accordance with one or more embodiments described herein.

Thus, while FIG. 23 depicts a UTSIP 2302 that can comprise an ultrasonic transceiver 2304, such as might be provided by an ultrasonic transceiver 2304 integrated with a processor and memory as a system-in-package, as further described below regarding FIG. 3, FIG. 24 depicts IC 2402 that can be associated with a discrete ultrasonic transceiver 2404, both of which can facilitate eye blink detection and/or classification in accordance with one or more embodiments described herein. In either case, exemplary integrated ultrasonic transceiver 2304 or discrete ultrasonic transceiver 2404 can be configured to generate ultrasonic time of flight range information to facilitate eye blink detection and/or classification in accordance with one or more embodiments described herein.

In a further non-limiting aspect, exemplary ultrasonic transceiver 2304/2404 can be positioned within the wearable device such that the field of view of the ultrasonic transceiver 2304/2404 will cover one or more body part or portions thereof of the user in wearing or operation of the device. In addition, eye blink detection and/or classification for battery-powered devices in accordance with one or more embodiments described herein may be useful in device contexts other than wearable devices, regardless of whether the devices can be strictly defined as “wearable,” for example such as for smart phones, video game controllers, and the like. Thus, exemplary ultrasonic transceiver 2304/2404 can be positioned within the device such that the field of view of the ultrasonic transceiver 2304/2404 will interact with one or more body part or portions thereof of the user (e.g., such as a user's eyes) in expected operation of the device. In either case, exemplary ultrasonic transceiver 2304/2404 can be positioned within the device such that the ultrasonic transceiver 2304/2404 can be expected to experience movement (e.g., such as is typical of eye movements) relative to the exemplary ultrasonic transceiver 2304/2404 when the wearable device is being worn by the user or the device is interacting or operating the device.

In various embodiments, exemplary UTSIP 2302 or IC 2402 can comprise or be associated with one or more computer-readable memory, such as memory 2306. In further embodiments, exemplary UTSIP 2302 or IC 2402 can comprise or be associated with one or more processors, such as, for example, processor 2308, that can be configured to execute computer-executable components stored in a computer-readable memory (e.g., memory 2306).

As a non-limiting example, computer-executable components that can be executed by processor 2308 can comprise an eye blink detection classifier component 2310 that facilitates eye blink detection and/or classification in accordance with one or more embodiments described herein. For instance, an exemplary eye blink detection classifier component 2310 can be configured as described herein to generate a classification of ultrasonic information (e.g., received from ultrasonic transceiver 2304) as indicative of at least one of liveness, an eye blink, a predetermined set of eye blinks, or a predetermined blinking pattern of a user of a wearable device comprising exemplary UTSIP 2302 or IC 2402 via an eye blink classification algorithm, for example, as further described herein.

As another non-limiting example, computer-executable components that can be executed by processor 2308 can comprise a determination component 2312 that facilitates eye blink detection and/or classification in accordance with one or more embodiments described herein. For instance, an exemplary determination component 2312 can be configured to generate a confirmation of the liveness or a determination of the eye blink, the predetermined set of eye blinks, or the predetermined blinking pattern of the user of the wearable device based on the classification (e.g., via exemplary eye blink detection classifier component 2310) of the ultrasonic information as indicative of liveness, the eye blink, the predetermined set of eye blinks, or the predetermined blinking pattern of the user of the wearable device comprising the apparatus via the eye blink classification algorithm, for example, as further described herein.

Moreover, as further described herein, an exemplary determination component 2312 can be configured to generate the confirmation of liveness or the determination of the eye blink, the predetermined set of eye blinks, or the predetermined blinking pattern of the user of the wearable device based on the classification (e.g., via exemplary eye blink detection classifier component 2310) and on one or more other inputs, either available by one or more sensors (not shown) associated with exemplary determination component 2312, or otherwise. For example, further non-limiting embodiments can include or be associated with one or more sensors (not shown) other than an ultrasonic sensor, e.g., infrared sensor, temperature sensor, accelerometer, gyroscope, environmental sensor, acoustic sensor, camera, and so on, without limitation, and exemplary determination component 2312 can be configured to process such inputs in addition to the classification (e.g., via exemplary eye blink detection classifier component 2310) to facilitate generating the confirmation of liveness or the determination of the eye blink, the predetermined set of eye blinks, or the predetermined blinking pattern of the user of the wearable device.

For instance, exemplary ultrasonic transceiver 2304/2404 can be configured to emit ultrasonic pulses and receive echoes as ultrasonic information, as further described herein regarding FIGS. 5-6. In yet another non-limiting aspect, an exemplary eye blink classification algorithm as described herein can be configured to analyze expected echoes of the ultrasonic pulses on the user to determine whether the user is blinking (e.g., normally, or otherwise, in an attempt to generate a control input via a UI, or otherwise). In still further non-limiting aspects, exemplary determination component 2312 can be configured to generate the confirmation or determination of the liveness or the eye blink or the predetermined set of eye blinks of the user of the wearable device to determine a donned or a doffed state of the wearable device, based on one of an eye blink detection classifier component classification of the eye blink or the predetermined set of eye blinks, for example, as further described herein regarding FIGS. 25-28.

In other non-limiting embodiments, computer-executable components that can be executed by processor 2308 can comprise a user interface (UI) component 2314 that can be configured to generate one or more of a data set or instruction(s) to facilitate user control of the wearable device based on the eye blink detection and/or classification in accordance with one or more embodiments described herein. For instance, an exemplary UI component 2314 can be configured as described herein to generate one or more of a data set or instruction(s) to facilitate user control of the wearable device based on confirmation of the liveness or the determination of the eye blink, the predetermined set of eye blinks, or the predetermined blinking pattern of the user of the wearable device, and/or any combination thereof.

While not shown in FIGS. 23 and 24, exemplary UTSIP 2302 or IC 2402 can comprise or be associated with various communications and I/O functionality (e.g., serial peripheral interface (SPI), general purpose I/O (GPIO), and so on for the purpose of communications and control among exemplary UTSIP 2302 or IC 2402 and a host system such as a host processor, an applications processor, and the like to facilitate user control via UI component 2314 of the wearable device (or other battery-powered device), processor 2308, a host system such as a host processor, an applications processor, or other systems or devices with which a user can interact via the wearable device, based (e.g., via exemplary determination component 2312) based on the confirmation of the liveness or the determination of the eye blink, the predetermined set of eye blinks, or the predetermined blinking pattern of the user of the wearable device, for example, as similarly described herein regarding FIGS. 3-4.

In various embodiments described herein, an exemplary eye blink classification algorithm can be based on a machine learning (ML) model trained on captured and classified ultrasonic information received during a number of states of use of a test wearable device (or a test device for non-wearable devices). For instance, FIGS. 23 and 24 depict exemplary UTSIP 2302 or IC 2402 associated with exemplary machine learning (ML) model training system 2316. In non-limiting aspects, exemplary ML model training system 2316 can comprise or be associated with a body of training data 2318, which typically comprises a database of labeled data, wherein the labeled data comprises a set of observations of the data of interest (here, echoes of the transmitted ultrasonic pulses from a test device comprising ultrasonic transceiver 2304/2404) labeled or annotated with classifications of the data), with which the exemplary ML model training system 2316 can employ an exemplary ML framework 2320 to generate an exemplary ML model 2322.

As described herein, ML frameworks provide software libraries and application programming interfaces (APIs) for tasks like data preprocessing, model building, and the like to facilitate development of ML models such as exemplary ML model 2322. One popular ML framework is TensorFlow, which can be used to develop an exemplary ML model 2322, for example, as further described herein. As a non-limiting example, exemplary ML model training system 2316 can be employed to produce an exemplary ML model 2322 for the classification of ultrasonic information as indicative of proximity or liveness of a user of a wearable device (or a device in use). Thereafter, specific implementations of the exemplary ML model 2322 can be compiled for specific hardware implementations such as exemplary UTSIP 2302 or IC 2402 in conjunction with ultrasonic transceiver 2304/2404, for example to produce an exemplary eye blink detection classifier component 2310, exemplary determination component 2312, and the like that facilitate eye blink detection and/or classification in accordance with one or more embodiments described herein.

As further described herein, these hardware specific ML model components can be stored in one or more computer-readable memory, such as memory 2306, associated with exemplary UTSIP 2302 or IC 2402, and one or more processors such as exemplary processor 2308 can be configured to execute the computer-executable ML model components (e.g., exemplary eye blink detection classifier component 2310, exemplary determination component 2312, and the like) stored in the computer-readable memory (e.g., memory 2306) to facilitate eye blink detection and/or classification in accordance with one or more embodiments described herein. Further description of training and execution of various embodiments that employ ML models to facilitate eye blink detection and/or classification are provided regarding specific non-limiting implementations, for example, regarding FIGS. 25-28 and FIG. 29. It can be appreciated that once the computer-executable ML model components (e.g., exemplary eye blink detection classifier component 2310, exemplary determination component 2312, and the like) are deployed and stored in the computer-readable memory (e.g., memory 2306) to facilitate eye blink detection and/or classification in accordance with one or more embodiments described herein, the exemplary ML model training system 2316 is no longer necessary to the normal operation of the exemplary, non-limiting UTSIP apparatus or device 2302, IC apparatus or device 2402 and so. However, it can be further appreciated that data obtained by non-limiting UTSIP apparatus or device 2302, IC apparatus or device 2402, and classifications made thereon can be back-propagated to exemplary ML model training system 2316, for example, to improve the training data 2318, create and/or retrain exemplary ML model 2322, and so on, according to further non-limiting aspects.

As described above, regarding FIGS. 5-8, for example, to facilitate eye blink detection and/or classification in various disclosed embodiments, the employed ultrasonic transceiver (e.g., exemplary ultrasonic transceiver 2304/2404) can emit an ultrasonic pulse and can detect reflected echoes, which amplitude can be sampled to create an ultrasonic magnitude profile, where each value of the profile corresponds to a particular distance from the sensor, for example, as depicted below regarding FIGS. 25-28. As further described herein, various eye blinks and/or sets or patterns thereof can be clearly distinguished from periods without eye blink (as well as from other eye blinks and/or sets or patterns thereof) by analyzing the ultrasonic magnitude profile, for example, as further described herein regarding liveness and/or proximity detection. As a result, various embodiments can employ an eye blink detection classifier using machine learning trained to automatically detect and classify different types of eye blinks and/or sets or patterns thereof to facilitate UI control of the wearable device associated applications, processors, systems such as host systems, and so on via the novel applications of machine learning algorithms as described herein.

FIG. 25 depicts non-limiting aspects 2500 regarding a UTSIP apparatus or device (e.g., exemplary UTSIP 2302, IC 2402 and ultrasonic transceiver 2404) signal that can facilitate eye blink detection and/or classification in accordance with one or more embodiments described herein. For instance, FIG. 25 depicts a three dimensional contour plot of exemplary pulse-echo responses over time of a natural (e.g., involuntary) short eye blink 2502 for a test device and an exemplary pulse-echo response of a voluntary long eye blink 2504 for a test device, where pulse-echo responses of eyes closed 2506 are indicated, and which disparate, distinctive pulse-echo responses show significant target detection variability in the three dimensional contour plot of exemplary pulse-echo responses. Note that FIG. 25 depicts pulse-echo responses where the primary sensing range of interest for a particular non-limiting implementation of a non-limiting apparatus or device that facilitates eye blink detection and/or classification as described herein occurs in the three dimensional contour plot from about 0 cm to around 20 cm. The data in FIG. 25 was obtained at an output data rate of 5, frame rate of 50 Hertz (Hz), with ultrasonic transceiver (e.g., exemplary ultrasonic transceiver 2304/2404) directed roughly at the center of the forehead on a wearable HMD test device, with a detection range of 38 millimeters (mm) to 256 mm.

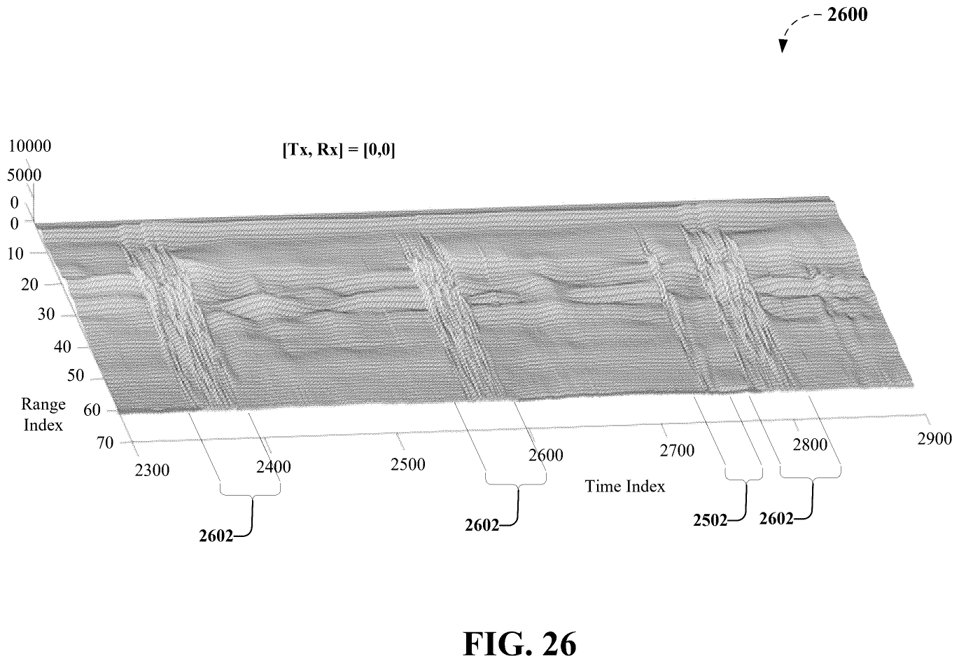

FIG. 26 depicts further non-limiting aspects 2600 regarding a UTSIP apparatus or device (e.g., exemplary UTSIP 2302, IC 2402 and ultrasonic transceiver 2404) signal that can facilitate eye blink detection and/or classification in accordance with one or more embodiments described herein. For instance, FIG. 26 depicts a three dimensional contour plot of exemplary pulse-echo responses over time of a natural (e.g., involuntary) short eye blink 2502 for a test device and an exemplary pulse-echo response of a double eye blink 2602 (e.g., two eye blinks in rapid succession) for a test device, which disparate, distinctive pulse-echo responses show significant target detection variability in the three dimensional contour plot of exemplary pulse-echo responses. Note that FIG. 26 depicts pulse-echo responses where the primary sensing range of interest for a particular non-limiting implementation of a non-limiting apparatus or device that facilitates eye blink detection and/or classification as described herein occurs in the three dimensional contour plot from about 0 cm to around 20 cm. As described above regarding FIG. 25, data in FIG. 26 was obtained at an output data rate of 5, frame rate of 50 Hz, with ultrasonic transceiver (e.g., exemplary ultrasonic transceiver 2304/2404) directed roughly at the center of the forehead on a wearable HMD test device, with a detection range of 38 millimeters (mm) to 256 mm.

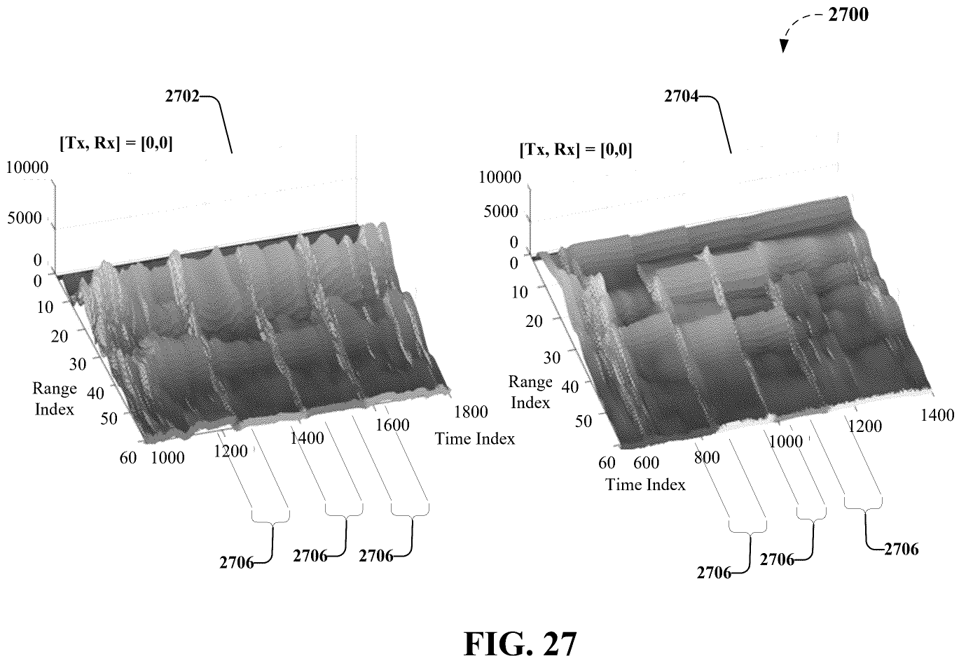

FIG. 27 depicts other non-limiting aspects 2700 regarding a UTSIP apparatus or device (e.g., exemplary UTSIP 2302, IC 2402 and ultrasonic transceiver 2404) signal that can facilitate eye blink detection and/or classification in accordance with one or more embodiments described herein. For instance, FIG. 27 depicts three dimensional contour plots 2702/2704 of exemplary pulse-echo responses over time for a user without wearing glasses 2702 and while wearing glasses 2704 of a natural (e.g., involuntary) short eye blink 2706 for a test device, distinctive pulse-echo responses exhibit robust and significant target detection characteristics, regardless of whether a user is wearing glasses. As with FIGS. 25-26, FIG. 27 depicts pulse-echo responses where the primary sensing range of interest for a particular non-limiting implementation of a non-limiting apparatus or device that facilitates eye blink detection and/or classification as described herein occurs in the three dimensional contour plot from about 0 cm to around 20 cm. As described above regarding FIGS. 25-26, data in FIG. 27 was obtained at an output data rate of 5, frame rate of 50 Hz, with ultrasonic transceiver (e.g., exemplary ultrasonic transceiver 2304/2404) directed roughly at the center of the forehead on a wearable HMD test device, with a detection range of 38 millimeters (mm) to 256 mm.

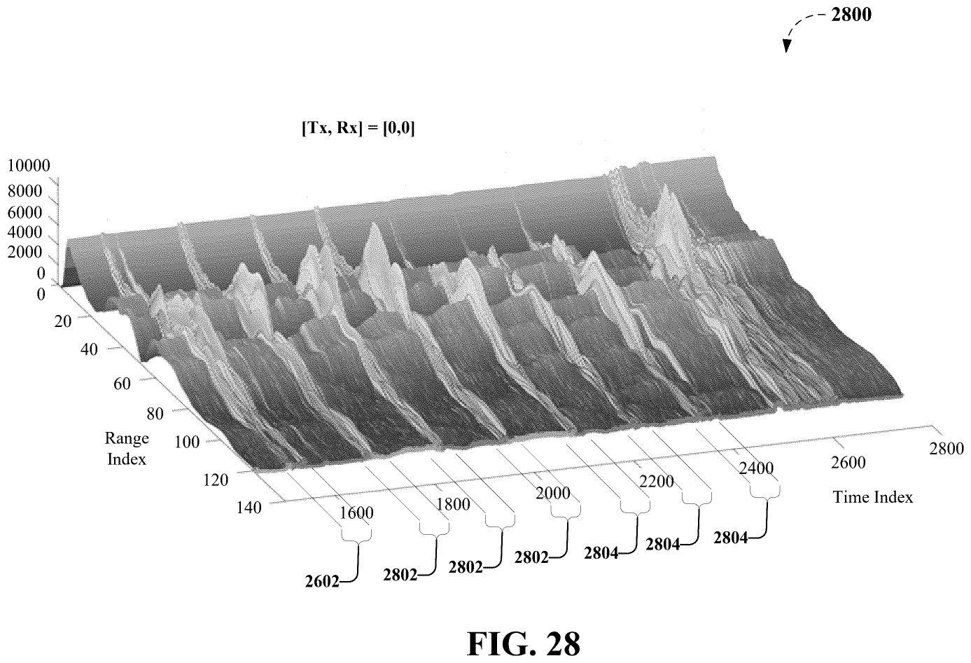

FIG. 28 depicts still further non-limiting aspects 2800 regarding a UTSIP apparatus or device (e.g., exemplary UTSIP 2302, IC 2402 and ultrasonic transceiver 2404) signal that can facilitate eye blink detection and/or classification in accordance with one or more embodiments described herein. For instance, FIG. 28 depicts a three dimensional contour plots of exemplary pulse-echo responses over time for a user winking with the right eye 2802 and left eye 2804, with a double eye blink 2602 (e.g., two eye blinks in rapid succession) for a test device, which disparate, distinctive pulse-echo responses show significant target detection variability in the three dimensional contour plot of exemplary pulse-echo responses, and which demonstrates the possibility of employing right/left winking in the various embodiments described herein. In contrast to that shown in FIGS. 25-27, FIG. 28 depicts pulse-echo responses where the primary sensing range of interest for a particular non-limiting implementation of a non-limiting apparatus or device that facilitates eye blink detection and/or classification as described herein occurs in the three dimensional contour plot from a range index of about 20 to a range index of around 80 (corresponding to a distance of about 74 mm to 185 mm, for the particular, non-limiting implementation), as a result of placement of the transceiver (e.g., exemplary ultrasonic transceiver 2304/2404) on the user's right side of the test device. In addition, data in FIG. 28 was obtained at an output data rate of 6, frame rate of 50 Hz, with ultrasonic transceiver (e.g., exemplary ultrasonic transceiver 2304/2404) directed roughly at the right temple of the user wearing a wearable HMD test device, with a detection range from a range index of about 0 to around 120 (corresponding to a distance of about 38 millimeters (mm) to about 256 mm, for the particular, non-limiting implementation).

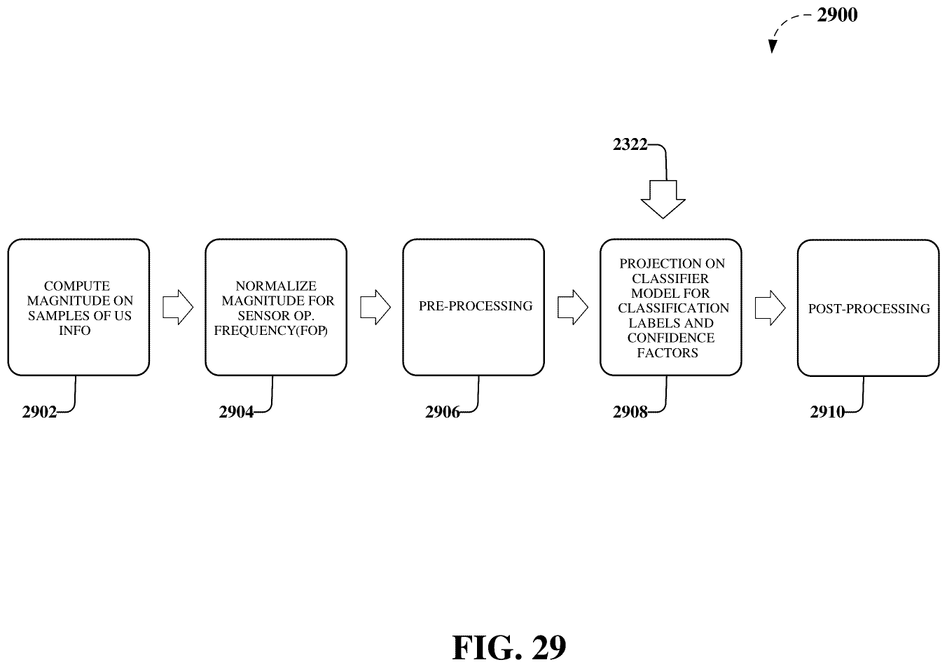

FIG. 29 depicts another block diagram 2900 illustrating further non-limiting aspects of exemplary apparatuses or devices that facilitate eye blink detection and/or classification in accordance with one or more embodiments described herein. For instance, FIG. 29 depicts runtime processes for an exemplary eye blink classification algorithm including a ML model 2322 (e.g., such as described above regarding ML classifier model 808) that can be compiled and propagated to an exemplary UTSIP apparatus or device (e.g., exemplary UTSIP 2302, exemplary IC 2402 with ultrasonic transceiver 2404, exemplary UTSIP apparatus or device 302), as further described herein along with and preprocessing and postprocessing of ultrasonic information before and after ML model 2322 such as described above regarding classifier model 808 classification using a decision tree classifier. For instance, an exemplary ML framework 2320 can generate several models, with various classifier types being possible including a decision tree, random forest, support vector machine (SVM), and/or neural networks (e.g., including tiny DNN, RNN) and the like. Thus, while various disclosed embodiments are described in non-limiting terms of a decision tree classifier, a RNN, a GRU RNN, and so on regarding liveness and/or proximity detection, for example, regarding FIGS. 8, 12, and 17-20, or an RNN regarding FIG. 29, the disclosed subject matter is not so limited. Accordingly, various non-limiting embodiments can facilitate eye blink detection and/or classification in accordance with one or more embodiments described herein by employing any of a number of machine learning methods, including but not limited to, random forest, gradient boosting decision tree, SVM, logistic regression, neural networks, naive bayes, gaussian mixture models, etc.

In a non-limiting aspect, exemplary eye blink classification algorithm in a ML model 2322 (e.g., such as described above regarding ML classifier model 808) can comprise a eye blink detection classifier trained on captured and classified ultrasonic information received during a set of states of use of a test wearable device (or other device). As a non-limiting example, the exemplary eye blink classification algorithm can be executed on every new frame of pulse-echo ultrasonic information (e.g., with roughly 50 frames/second). As further described herein regarding FIGS. 23-24, for example, an exemplary eye blink detection classifier component 2310 can be configured to generate the classification of the ultrasonic information as indicative of liveness, an eye blink, a predetermined set of eye blinks, or a predetermined blinking pattern of a user of a wearable device via an eye blink classification algorithm.

Accordingly, exemplary eye blink classification algorithm can be configured to compute magnitude of samples of ultrasonic information at 2902. In addition, exemplary eye blink classification algorithm can be further configured to normalize the magnitude of samples of ultrasonic information as a function of ultrasonic transceiver (e.g., ultrasonic transceiver 2304/2404/304) operating frequency (Fop) at 2904 to generate normalized magnitude ultrasonic information. Furthermore, exemplary eye blink classification algorithm can be further configured to perform pre-processing on the normalized magnitude ultrasonic information, for example, such as performing one or more of amplitude normalization, special decimation, and/or computation of a set of feature vectors in the normalized magnitude ultrasonic information at 2906.

Moreover, exemplary eye blink classification algorithm can be further configured to determine a set of feature classification labels (e.g., for the computed feature vectors) and corresponding confidence factors using the eye blink detection classifier at 2908 (e.g., such as via an RNN or other suitable ML model 2322), which can generate an overall classification label or prediction per class and a confidence factor or probability score per class. Accordingly, exemplary determination component 2312 can be configured to generate a confirmation of the liveness or a determination of the eye blink, the predetermined set of eye blinks, or the predetermined blinking pattern of the user of the wearable device based on the set of feature classification labels or predictions and corresponding confidence factors or probability scores.

In addition, exemplary eye blink classification algorithm can comprise classifier post processing at 2910. As a non-limiting example, exemplary eye blink classification algorithm including a ML model 2322 can result in an output comprising one or more of classifier event(s) (e.g., classification labels or predictions), corresponding confidence factors or probability scores, and/or current state. Exemplary post processing can include, but is not limited to, recursively averaging probability scores to stabilizing output, threshold comparisons, and so on. In addition, as further described herein, an exemplary determination component 2312 can be configured to generate the confirmation of liveness or the determination of the eye blink, the predetermined set of eye blinks, or the predetermined blinking pattern of the user of the wearable device based on the classification (e.g., via exemplary eye blink detection classifier component 2310) and on one or more other inputs, either available by one or more sensors (not shown) associated with exemplary determination component 2312, or otherwise. For example, further non-limiting embodiments can include or be associated with one or more sensors (not shown) other than an ultrasonic sensor, e.g., infrared sensor, temperature sensor, accelerometer, gyroscope, environmental sensor, acoustic sensor, camera, and so on, without limitation, and exemplary determination component 2312 can be configured to process such inputs in addition to the classification (e.g., via exemplary eye blink detection classifier component 2310) to facilitate generating the confirmation of liveness or the determination of the eye blink, the predetermined set of eye blinks, or the predetermined blinking pattern of the user of the wearable device.

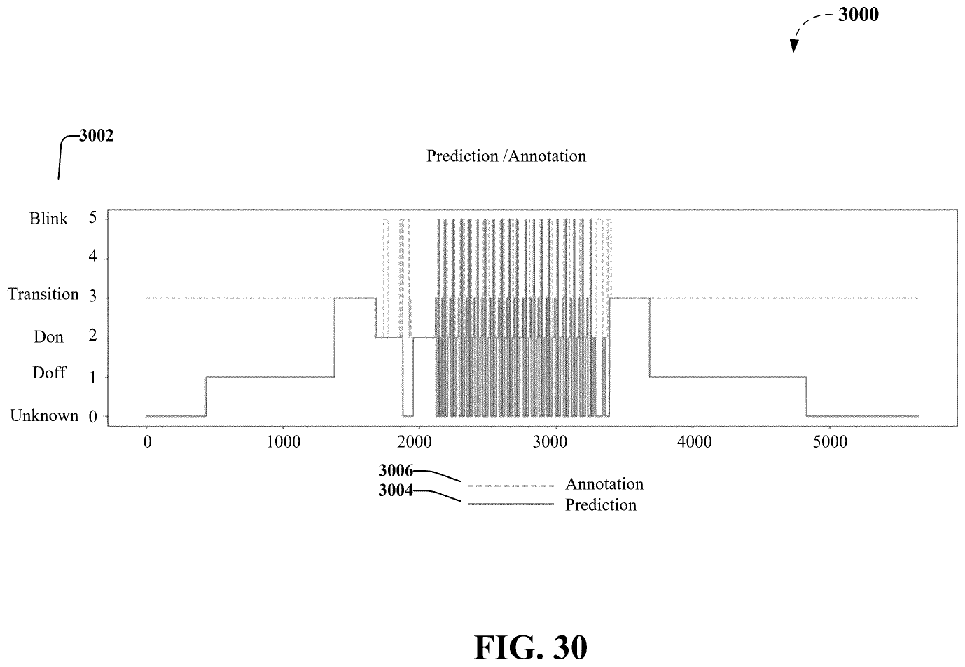

Accordingly, various embodiments as described herein can provide an exemplary UTSIP apparatus or device (e.g., exemplary UTSIP 2302, exemplary IC 2402 with ultrasonic transceiver 2404, exemplary UTSIP apparatus or device 302) that can facilitate eye blink detection and/or classification based on a ML model 2322 as further described herein. For instance, FIG. 30 depicts non-limiting aspects 3000 regarding performance of eye blink detection and/or classification of an employed eye blink classification algorithm against annotated 3002 data sets (e.g., comprising classification label of data for a blink, don state, doff state, transitional state, and unknown) according to various embodiments described herein. A review of FIG. 30 reveals about an 80 percent (%) correspondence between eye blink classification algorithm predictions 3004 and annotations 3006, verifying the viability of exemplary UTSIP apparatus or device (e.g., exemplary UTSIP 2302, exemplary IC 2402 with ultrasonic transceiver 2404, exemplary UTSIP apparatus or device 302) facilitating eye blink detection and/or classification based on a ML model 2322 and employing such eye blink detection and/or classification as a control input to a user interface of a wearable device such as an HMD and the like, as further described herein.

Accordingly, various embodiments described herein can facilitate eye blink detection and/or classification based on a ML model 2322 via exemplary UTSIP apparatus or device (e.g., exemplary UTSIP 2302, exemplary IC 2402 with ultrasonic transceiver 2404, exemplary UTSIP apparatus or device 302). In further non-limiting aspects, various embodiments can facilitate user control via UI component 2314 of the wearable device (or other battery-powered device), processor 2308, a host system such as a host processor, an applications processor, or other systems or devices with which a user can interact via the wearable device, based (e.g., via exemplary determination component 2312) based on the confirmation of the liveness or the determination of the eye blink, the predetermined set of eye blinks (e.g., variation in number), or the predetermined blinking pattern (e.g., variation in number, duration, number of eyes winking or blinking, and so on) of the user of the wearable device, for example, as similarly described herein regarding FIGS. 3-4, to facilitate hands-free control of the wearable device such as an HMD or the like. In addition, various embodiments as described herein can facilitate generating a confirmation of liveness (e.g., donned or worn state of wearable device such as an HMD and the like) of a user, for example, by facilitating eye blink detection and/or classification based on a ML model 2322 of a natural or involuntary eye blink 2502.

Accordingly, various embodiments described herein can enable simple, low power (e.g., and therefor available as an always on solution), low latency (e.g., less than 0.5 seconds(s) after end of blink using frame rate of 25 Hz or more), secure, and robust (e.g., robust to ambient noise, lighting, head motion, user wearing glasses or not, skin color, facial hair, hair, and so on), hands-free user control via UI component 2314 of the wearable device (or other battery-powered device), processor 2308, a host system such as a host processor, an applications processor, or other systems or devices with which a user can interact via the wearable device, based (e.g., via exemplary determination component 2312) based on the confirmation of the liveness or the determination of the eye blink, the predetermined set of eye blinks (e.g., variation in number), or the predetermined blinking pattern (e.g., variation in number, duration, number of eyes winking or blinking, and so on) of the user of the wearable device, for example, as similarly described herein regarding FIGS. 3-4. In addition, because users of wearable devices such as HMDs typically have their eyes obscured from view, various embodiments described herein that facilitate eye blink detection and/or classification based on a ML model 2322 of a voluntary long eye blink 2504, double eye blink 2602, right eye wink 2802, left eye wink 2804, and the like can enable secure, hands-free authentication of a user of a wearable device such as an HMD, thereby replacing passwords with sequences and patterns of voluntary long eye blink 2504, double eye blink 2602, right eye wink 2802, left eye wink 2804, and the like, secure from being observed by others.

Accordingly, various non-limiting embodiments that facilitate eye blink detection and/or classification can comprise a processor (e.g., processor 2308, MCU 312), that executes computer-executable components stored in a computer-readable memory (e.g., memory 2306, program memory 314). In addition, further non-limiting embodiments that facilitate eye blink detection and/or classification can comprise an ultrasonic transceiver (e.g., ultrasonic transceiver 2304/2404/304) configured to generate the ultrasonic information, for example, as described herein regarding FIGS. 3 and 23-24. In a non-limiting aspect, exemplary ultrasonic information can comprise ultrasonic time of flight range information. In another non-limiting aspect, exemplary ultrasonic transceiver (e.g., ultrasonic transceiver 2304/2404/304) can be positioned within the wearable device (e.g., wearable device or other device comprising exemplary UTSIP 2302 or IC 2402) such that the field of view of the ultrasonic transceiver (e.g., ultrasonic transceiver 2304/2404/304) will sense at least one eye of the user when the wearable device (e.g., wearable device or other device comprising exemplary UTSIP 2302 or IC 2402) is being worn by the user, for example, as described herein regarding FIGS. 23-24. In still another non-limiting aspect, exemplary ultrasonic transceiver (e.g., ultrasonic transceiver 2304/2404/304) can be configured to emit ultrasonic pulses and receive echoes as the ultrasonic information, and wherein the eye blink classification algorithm can be configured to analyze expected echoes of the ultrasonic pulses on the user to provide the confirmation of the liveness of the user or the determination of the eye blink, the predetermined set of eye blinks, or the predetermined blinking pattern (or combinations thereof) by the user, for example, as described herein regarding FIGS. 23-29.

Further non-limiting embodiments that facilitate eye blink detection and/or classification can comprise an eye blink detection classifier component (e.g., eye blink detection classifier component 2310) that generates a classification of ultrasonic information as indicative of liveness, an eye blink, a predetermined set of eye blinks, or a predetermined blinking pattern (or combinations thereof) of a user of a wearable device (e.g., wearable device or other device comprising exemplary UTSIP 2302 or IC 2402) comprising the apparatus via an eye blink classification algorithm. As a non-limiting example, an exemplary eye blink classification algorithm can be based on a machine learning model (e.g., machine learning model 2322) trained on captured and classified ultrasonic information received during one or more of states of use of a test wearable device (e.g., wearable device or other device comprising exemplary UTSIP 2302 or IC 2402), for example, as described herein regarding FIGS. 23-29. In another non-limiting aspect, an exemplary machine learning model (e.g., machine learning model 2322) can be based on an eye blink detection classifier trained on the captured and the classified ultrasonic information received during the one or more of states of use of the test wearable device (e.g., wearable device or other device comprising exemplary UTSIP 2302 or IC 2402), for example, as described herein regarding FIGS. 23-29.

In a non-limiting aspect, an exemplary machine learning model (e.g., machine learning model 2322) can be based on an eye blink detection classifier recursive recurrent neural network (RNN) or an eye blink detection classifier decision tree trained on the captured and the classified ultrasonic information received during the number of states of use of the test wearable device (e.g., wearable device or other device comprising exemplary UTSIP 2302 or IC 2402), for example, as further described herein. In another non-limiting aspect, an exemplary eye blink detection classifier RNN can comprise a gated-recurrent unit (GRU) trained on the captured and the classified ultrasonic information received during the number of states of use of the test wearable device (e.g., wearable device or other device comprising exemplary UTSIP 2302 or IC 2402), for example, as further described herein. In still further non-limiting aspects, an exemplary GRU, for a number of measurement vectors associated with the ultrasonic information, can be configured to generate a classification prediction of at least one of the eye blink, the predetermined set of eye blinks, or the predetermined blinking pattern of the user of the wearable device (e.g., wearable device or other device comprising exemplary UTSIP 2302 or IC 2402).

Non-limiting embodiments that facilitate eye blink detection and/or classification comprising exemplary eye blink detection classifier component (e.g., eye blink detection classifier component 2310) can be configured to generate the classification of the ultrasonic information as indicative of the liveness, the eye blink, the predetermined set of eye blinks, or the predetermined blinking pattern (or combinations thereof) based on the eye blink classification algorithm, wherein the eye blink classification algorithm can be configured to compute magnitude of samples of ultrasonic information, wherein the eye blink classification algorithm can be configured to normalize the magnitude of samples of ultrasonic information as a function of ultrasonic transceiver (e.g., ultrasonic transceiver 2304/2404/304) operating frequency to generate normalized magnitude ultrasonic information, wherein the eye blink classification algorithm can be configured to compute a set of feature vectors in the normalized magnitude ultrasonic information, and wherein the eye blink classification algorithm can be configured to determine a set of feature classification labels and corresponding confidence factors using the eye blink detection classifier, for example, as described herein regarding FIG. 29.

In addition, further non-limiting embodiments that facilitate eye blink detection and/or classification can comprise an exemplary eye blink detection classifier component (e.g., eye blink detection classifier component 2310) that, for one or more measurement vectors associated with the ultrasonic information, can be configured to generate a classification prediction of one of the eye blink, the predetermined set of eye blinks, or the predetermined blinking pattern (or combinations thereof) of the user of the wearable device (e.g., wearable device or other device comprising exemplary UTSIP 2302 or IC 2402), for example, as described herein regarding FIG. 29. In still further non-limiting aspects, an exemplary eye blink detection classifier component (e.g., eye blink detection classifier component 2310) can be further configured to distinguish between a natural eye blink, characterized by a nominal eye blink speed, duration, or interval, and a voluntary long blink, the predetermined set of eye blinks comprising one or more of eye blinks, or the predetermined blinking pattern (or combinations thereof), for example, as described herein regarding FIGS. 23-29. For instance, and exemplary predetermined blinking pattern can comprise the eye blinks, wherein characteristics of each eye blink of the eye blinks differ from a successive eye blink in one or more of blink speed, blink duration, interval to next eye blink, or which one or both of the left eye blink or right eye blink, for example, as further described herein regarding FIGS. 23-29.

Still other non-limiting embodiments that facilitate eye blink detection and/or classification can comprise a determination component (e.g., determination component 2312) configured to generate a confirmation of the liveness or a determination of the eye blink, the predetermined set of eye blinks, or the predetermined blinking pattern (or combinations thereof) of the user of the wearable device (e.g., wearable device or other device comprising exemplary UTSIP 2302 or IC 2402) based on the classification. In a non-limiting aspect, an exemplary determination component (e.g., determination component 2312) can be configured to generate the confirmation of the liveness or the determination of the eye blink, the predetermined set of eye blinks, or the predetermined blinking pattern (or combinations thereof) based on the set of feature classification labels and corresponding confidence factors, for example, as further described herein regarding FIG. 29. In further non-limiting aspects, an exemplary determination component (e.g., determination component 2312) can be further configured to generate the confirmation or determination of the liveness or the eye blink or the predetermined set of eye blinks of the user of the wearable device (e.g., wearable device or other device comprising exemplary UTSIP 2302 or IC 2402) to determine a donned or a doffed state of the wearable device (e.g., wearable device or other device comprising exemplary UTSIP 2302 or IC 2402), based on an eye blink detection classifier component (e.g., eye blink detection classifier component 2310) classification of the eye blink or the predetermined set of eye blinks, as further described herein.

In addition, non-limiting embodiments that facilitate eye blink detection and/or classification can comprise a user interface (UI) component (e.g., UI component 2314) configured to generate a data set or instruction configured to facilitate user control of the wearable device (e.g., wearable device or other device comprising exemplary UTSIP 2302 or IC 2402) based on the confirmation of the liveness or the determination of the eye blink, the predetermined set of eye blinks, or the predetermined blinking pattern (or combinations thereof) of the user of the wearable device (e.g., wearable device or other device comprising exemplary UTSIP 2302 or IC 2402). In a non-limiting aspect, an exemplary UI component can be further configured to generate the data set or instruction that facilitates user authentication of the user of the wearable device (e.g., wearable device or other device comprising exemplary UTSIP 2302 or IC 2402) based on the determination of the eye blink, the predetermined set of eye blinks, or the predetermined blinking pattern (or combinations thereof) of the user of the wearable device (e.g., wearable device or other device comprising exemplary UTSIP 2302 or IC 2402), as further described herein.

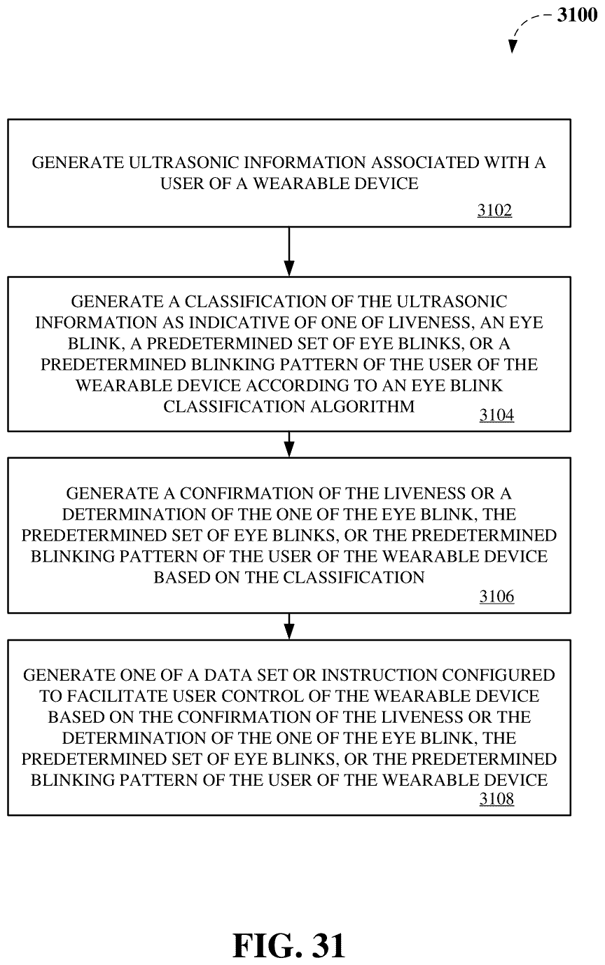

In view of the subject matter described supra, methods that can be implemented in accordance with the subject disclosure will be better appreciated with reference to the flowcharts of FIG. 31. As described above, while for purposes of simplicity of explanation, the methods are shown and described as a series of blocks, it is to be understood and appreciated that such illustrations or corresponding descriptions are not limited by the order of the blocks, as some blocks may occur in different orders and/or concurrently with other blocks from what is depicted and described herein. Any non-sequential, or branched, flow illustrated via a flowchart should be understood to indicate that various other branches, flow paths, and orders of the blocks, can be implemented which achieve the same or a similar result. Moreover, not all illustrated blocks may be required to implement the methods described hereinafter.

FIG. 31 illustrates a non-limiting flow diagram of exemplary methods 3100 that facilitate eye blink detection and/or classification in accordance with one or more embodiments described herein. In non-limiting embodiments, exemplary methods 3100 can comprise, at 3102, generating, by an ultrasonic transceiver (e.g., ultrasonic transceiver 2304/2404/304) operatively coupled to a processor (e.g., processor 2308, MCU 312), ultrasonic information associated with a user of a wearable device (e.g., wearable device or other device comprising exemplary UTSIP 2302 or IC 2402), for example, as further described herein regarding FIG. 23-24. In a non-limiting aspect, exemplary methods 3100 can further comprise generating the classification, via the eye blink detection classifier component (e.g., eye blink detection classifier component 2310) configured to generate the classification of the ultrasonic information as indicative of the liveness, the eye blink, the predetermined set of eye blinks, or the predetermined blinking pattern (or combinations thereof) by the user based on the eye blink classification algorithm, including computing magnitude of samples of ultrasonic information, normalizing the magnitude of samples of ultrasonic information as a function of ultrasonic transceiver (e.g., ultrasonic transceiver 2304/2404/304) operating frequency to generate normalized magnitude ultrasonic information, computing a set of feature vectors in the normalized magnitude ultrasonic information, and determining a set of feature classification labels and corresponding confidence factors using an eye blink detection classifier trained on captured and classified ultrasonic information received during one or more of states of use of a test wearable device (e.g., wearable device or other device comprising exemplary UTSIP 2302 or IC 2402).

In further non-limiting embodiments, exemplary methods 3100 can comprise, at 3104, generating a classification, via an eye blink detection classifier component (e.g., eye blink detection classifier component 2310) associated with a memory (e.g., memory 2306, program memory 314) coupled to the processor (e.g., processor 2308, MCU 312), of the ultrasonic information as indicative of liveness, an eye blink, a predetermined set of eye blinks, or a predetermined blinking pattern (or combinations thereof) of the user of the wearable device (e.g., wearable device or other device comprising exemplary UTSIP 2302 or IC 2402) according to an eye blink classification algorithm executed by the processor (e.g., processor 2308, MCU 312), for example, as further described herein regarding FIG. 23-29. In a non-limiting aspect, exemplary methods 3100 can further comprise generating the classification via the eye blink detection classifier component (e.g., eye blink detection classifier component 2310) configured to distinguish between a natural eye blink, characterized by a nominal eye blink speed, duration, or interval, and a voluntary long blink, the predetermined set of eye blinks comprising one or more of eye blinks, or the predetermined blinking pattern (or combinations thereof). In addition, exemplary methods 3100 can further comprise generating the classification, via the eye blink detection classifier component (e.g., eye blink detection classifier component 2310), where the predetermined blinking pattern comprises the one or more of eye blinks, wherein characteristics of each eye blink of the one or more of eye blinks differ from a successive eye blink of the one or more of eye blinks in at least one of blink speed, blink duration, interval to next eye blink, or which one or both of the left eye blink or right eye blink.

In other non-limiting embodiments, exemplary methods 3100 can comprise, at 3106, generating a confirmation, via a determination component (e.g., determination component 2312) associated with the memory (e.g., memory 2306, program memory 314), of the liveness or a determination of the eye blink, the predetermined set of eye blinks, or the predetermined blinking pattern (or combinations thereof) of the user of the wearable device (e.g., wearable device or other device comprising exemplary UTSIP 2302 or IC 2402) based on the classification, for example, as further described herein regarding FIG. 23-29. In a non-limiting aspect, exemplary methods 3100 can further comprise generating the confirmation or the determination via the determination component (e.g., determination component 2312) configured to generate the confirmation of the liveness or the determination of the eye blink, the predetermined set of eye blinks, or the predetermined blinking pattern (or combinations thereof) by the user based on the set of feature classification labels and corresponding confidence factors. In addition, exemplary methods 3100 can further comprise generating the confirmation or the determination via the determination component (e.g., determination component 2312) configured to generate the confirmation of the liveness or the determination of the eye blink or the predetermined set of eye blinks of the user of the wearable device (e.g., wearable device or other device comprising exemplary UTSIP 2302 or IC 2402) to determine a donned or a doffed state of the wearable device (e.g., wearable device or other device comprising exemplary UTSIP 2302 or IC 2402), based on an eye blink detection classifier component (e.g., eye blink detection classifier component 2310) determination of one or more of eye blinks or the predetermined set of eye blinks.

In still other non-limiting embodiments, exemplary methods 3100 can comprise, at 3108, generating, via a user interface (UI) component (e.g., UI component 2314) associated with the memory (e.g., memory 2306, program memory 314), a data set or instruction configured to facilitate user control of the wearable device (e.g., wearable device or other device comprising exemplary UTSIP 2302 or IC 2402) based on the confirmation of the liveness or the determination of the eye blink, the predetermined set of eye blinks, or the predetermined blinking pattern (or combinations thereof) of the user of the wearable device (e.g., wearable device or other device comprising exemplary UTSIP 2302 or IC 2402), for example, as further described herein regarding FIG. 23-29. As a non-limiting example, at 3108, exemplary methods can further comprise generating, via the UI component (e.g., UI component 2314), the one or more of the data set or instruction configured to facilitate user control of the wearable device (e.g., wearable device or other device comprising exemplary UTSIP 2302 or IC 2402) wherein the UI component (e.g., UI component 2314) is further configured to generate the one or more of the data set or instruction that facilitates user authentication of the user of the wearable device (e.g., wearable device or other device comprising exemplary UTSIP 2302 or IC 2402) based at least in part on the determination of the one or more of the eye blink, the predetermined set of eye blinks, or the predetermined blinking pattern of the user of the wearable device (e.g., wearable device or other device comprising exemplary UTSIP 2302 or IC 2402), as further described herein.

In other non-limiting aspects, exemplary methods 3100 can further comprise generating ultrasonic information associated with the user of the wearable device (e.g., wearable device or other device comprising exemplary UTSIP 2302 or IC 2402) comprising generating ultrasonic time of flight range information, as further described herein. In a still other non-limiting aspects, exemplary methods 3100 can further comprise generating the ultrasonic information comprising emitting ultrasonic pulses and receiving echoes as the ultrasonic information, and wherein the generating the classification according to the eye blink classification algorithm can comprise analyzing expected echoes of the user to provide the confirmation of the liveness of the user or the determination of the one or more of the eye blink, the predetermined set of eye blinks, or the predetermined blinking pattern by the user.

In other non-limiting aspects, exemplary methods 3100 can further comprise generating the classification, via the eye blink detection classifier component (e.g., eye blink detection classifier component 2310), of the ultrasonic information as indicative of the one or more of the liveness, the eye blink, the predetermined set of eye blinks, or the predetermined blinking pattern based on the ultrasonic transceiver (e.g., ultrasonic transceiver 2304/2404/304) being positioned within the wearable device (e.g., wearable device or other device comprising exemplary UTSIP 2302 or IC 2402) such that the field of view of the ultrasonic transceiver (e.g., ultrasonic transceiver 2304/2404/304) will cover one or more body part of the user that experiences movement relative to the ultrasonic transceiver (e.g., ultrasonic transceiver 2304/2404/304) when the wearable device (e.g., wearable device or other device comprising exemplary UTSIP 2302 or IC 2402) is being worn by the user, as further described herein. In addition, exemplary methods 3100 can further comprise generating the classification according to the eye blink classification algorithm comprising generating the classification according to the eye blink classification algorithm based at least in part on a machine learning model (e.g., machine learning model 2322) trained on captured and classified ultrasonic information received during a number of states of use of a test wearable device (e.g., wearable device or other device comprising exemplary UTSIP 2302 or IC 2402). In a non-limiting aspect, generating the classification according to the eye blink classification algorithm can be based on the machine learning model (e.g., machine learning model 2322) comprising generating the classification based on the machine learning model (e.g., machine learning model 2322) involving an eye blink detection classifier trained on the captured and the classified ultrasonic information received during the number of states of use of the test wearable device (e.g., wearable device or other device comprising exemplary UTSIP 2302 or IC 2402), as further described herein.

Additionally, exemplary methods 3100 can further comprise generating the classification according to the eye blink classification algorithm based on the machine learning model (e.g., machine learning model 2322) comprising generating the classification based on the machine learning model (e.g., machine learning model 2322) involving an eye blink detection classifier recurrent neural network (RNN) trained on the captured and the classified ultrasonic information received during the number of states of use of the test wearable device (e.g., wearable device or other device comprising exemplary UTSIP 2302 or IC 2402). In a non-limiting aspect, generating the classification based on the machine learning model (e.g., machine learning model 2322) involving the eye blink detection classifier RNN can comprise generating the classification based on the machine learning model (e.g., machine learning model 2322) involving a gated-recurrent unit (GRU) trained on the captured and the classified ultrasonic information received during the number of states of use of the test wearable device (e.g., wearable device or other device comprising exemplary UTSIP 2302 or IC 2402), as further described herein. In addition, exemplary methods 3100 can further comprise generating the classification based on the machine learning model (e.g., machine learning model 2322) involving the GRU, for a number of measurement vectors associated with the ultrasonic information, comprising generating a classification prediction of the one or more of the eye blink, the predetermined set of eye blinks, or the predetermined blinking pattern of the user of the wearable device (e.g., wearable device or other device comprising exemplary UTSIP 2302 or IC 2402), as described herein.

What has been described above include mere examples of systems and computer-implemented methods. It is, of course, not possible to describe every conceivable combination of components or computer-implemented methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. An apparatus, comprising:
a processor that executes computer-executable components stored in a computer-readable memory, the computer-executable components comprising:
an eye blink detection classifier component that generates a classification of ultrasonic information as indicative of at least one of liveness, an eye blink, a predetermined set of eye blinks, or a predetermined blinking pattern of a user of a wearable device comprising the apparatus via an eye blink classification algorithm;
a determination component that generates a confirmation of the liveness or a determination of the at least one of the eye blink, the predetermined set of eye blinks, or the predetermined blinking pattern of the user of the wearable device based at least in part on the classification; and
a user interface (UI) component configured to generate at least one of a data set or instruction configured to facilitate user control of the wearable device based at least in part on the confirmation of the liveness or the determination of the at least one of the eye blink, the predetermined set of eye blinks, or the predetermined blinking pattern of the user of the wearable device.

2. The apparatus of claim 1, further comprising:
an ultrasonic transceiver that generates the ultrasonic information.

3. The apparatus of claim 2, wherein the ultrasonic information comprises ultrasonic time of flight range information.

4. The apparatus of claim 1, wherein the ultrasonic transceiver is positioned within the wearable device such that the field of view of the ultrasonic transceiver will sense at least one eye of the user when the wearable device is being worn by the user.

5. The apparatus of claim 1, wherein the ultrasonic transceiver is configured to emit ultrasonic pulses and receive echoes as the ultrasonic information, and wherein the eye blink classification algorithm is configured to analyze expected echoes of the ultrasonic pulses on the user to provide the confirmation of the liveness of the user or the determination of the at least one of the eye blink, the predetermined set of eye blinks, or the predetermined blinking pattern by the user.

6. The apparatus of claim 1, wherein the eye blink classification algorithm is based at least in part on a machine learning model trained on captured and classified ultrasonic information received during a plurality of states of use of a test wearable device.

7. The apparatus of claim 6, wherein the machine learning model is based on an eye blink detection classifier trained on the captured and the classified ultrasonic information received during the plurality of states of use of the test wearable device.

8. The apparatus of claim 7, wherein the eye blink detection classifier component is configured to generate the classification of the ultrasonic information as indicative of the at least one of the liveness, the eye blink, the predetermined set of eye blinks, or the predetermined blinking pattern based at least in part on the eye blink classification algorithm, wherein the eye blink classification algorithm is configured to compute magnitude of samples of ultrasonic information, wherein the eye blink classification algorithm is configured to normalize the magnitude of samples of ultrasonic information as a function of ultrasonic transceiver operating frequency to generate normalized magnitude ultrasonic information, wherein the eye blink classification algorithm is configured to compute a set of feature vectors in the normalized magnitude ultrasonic information, and wherein the eye blink classification algorithm is configured to determine a set of feature classification labels and corresponding confidence factors using the eye blink detection classifier.

9. The apparatus of claim 8, wherein the determination component is configured to generate the confirmation of the liveness or the determination of the at least one of the eye blink, the predetermined set of eye blinks, or the predetermined blinking pattern based at least in part on the set of feature classification labels and corresponding confidence factors.

10. The apparatus of claim 9, wherein the determination component is further configured to generate the confirmation or determination of the liveness or the at least one of the eye blink or the predetermined set of eye blinks of the user of the wearable device to determine a donned or a doffed state of the wearable device, based at least in part on at least one of an eye blink detection classifier component classification of the eye blink or the predetermined set of eye blinks.

11. The apparatus of claim 1, wherein the eye blink detection classifier component, for a plurality of measurement vectors associated with the ultrasonic information, is configured to generate a classification prediction of at least one of the eye blink, the predetermined set of eye blinks, or the predetermined blinking pattern of the user of the wearable device.

12. The apparatus of claim 1, wherein the eye blink detection classifier component is further configured to distinguish between a natural eye blink, characterized by at least one of a nominal eye blink speed, duration, or interval, and at least one of a voluntary long blink, the predetermined set of eye blinks comprising a plurality of eye blinks, or the predetermined blinking pattern.

13. The apparatus of claim 12, wherein the predetermined blinking pattern comprises the plurality of eye blinks, wherein characteristics of each eye blink of the plurality of eye blinks differ from a successive eye blink of the plurality of eye blinks in at least one of blink speed, blink duration, interval to next eye blink, or which one or both of the left eye blink or right eye blink.

14. The apparatus of claim 12, wherein the UI component is further configured to generate the at least one of the data set or instruction that facilitates user authentication of the user of the wearable device based at least in part on the determination of the at least one of the eye blink, the predetermined set of eye blinks, or the predetermined blinking pattern of the user of the wearable device.

15. A method, comprising:
generating, by an ultrasonic transceiver operatively coupled to a processor, ultrasonic information associated with a user of a wearable device;
generating a classification, via an eye blink detection classifier component associated with a memory coupled to the processor, of the ultrasonic information as indicative of at least one of liveness, an eye blink, a predetermined set of eye blinks, or a predetermined blinking pattern of the user of the wearable device according to an eye blink classification algorithm executed by the processor;
generating a confirmation, via a determination component associated with the memory, of the liveness or a determination of the at least one of the eye blink, the predetermined set of eye blinks, or the predetermined blinking pattern of the user of the wearable device based at least in part on the classification; and
generating, via a user interface (UI) component associated with the memory, at least one of a data set or instruction configured to facilitate user control of the wearable device based at least in part on the confirmation of the liveness or the determination of the at least one of the eye blink, the predetermined set of eye blinks, or the predetermined blinking pattern of the user of the wearable device.

16. The method of claim 15, wherein the generating the classification, via the eye blink detection classifier component, comprises generating the classification, via the eye blink detection classifier component configured to generate the classification of the ultrasonic information as indicative of the at least one of the liveness, the eye blink, the predetermined set of eye blinks, or the predetermined blinking pattern by the user based at least in part on the eye blink classification algorithm, including computing magnitude of samples of ultrasonic information, normalizing the magnitude of samples of ultrasonic information as a function of ultrasonic transceiver operating frequency to generate normalized magnitude ultrasonic information, computing a set of feature vectors in the normalized magnitude ultrasonic information, and determining a set of feature classification labels and corresponding confidence factors using an eye blink detection classifier trained on captured and classified ultrasonic information received during a plurality of states of use of a test wearable device.

17. The method of claim 16, wherein the generating the confirmation or the determination, via the determination component, comprises generating the confirmation or the determination via the determination component configured to generate the confirmation of the liveness or the determination of the at least one of the eye blink, the predetermined set of eye blinks, or the predetermined blinking pattern by the user based at least in part on the set of feature classification labels and corresponding confidence factors.

18. The method of claim 17, wherein the generating the confirmation or the determination, via the determination component, comprises generating the confirmation or the determination via the determination component configured to generate the confirmation of the liveness or the determination of the at least one of the eye blink or the predetermined set of eye blinks of the user of the wearable device to determine a donned or a doffed state of the wearable device, based at least in part on at least one of an eye blink detection classifier component determination of a plurality of eye blinks or the predetermined set of eye blinks.

19. The method of claim 17, wherein the generating the classification, via the eye blink detection classifier component, comprises generating the classification via the eye blink detection classifier component configured to distinguish between a natural eye blink, characterized by at least one of a nominal eye blink speed, duration, or interval, and at least one of a voluntary long blink, the predetermined set of eye blinks comprising a plurality of eye blinks, or the predetermined blinking pattern.

20. The method of claim 19, wherein generating the classification, via the eye blink detection classifier component, comprises generating the classification, via the eye blink detection classifier component, where the predetermined blinking pattern comprises the plurality of eye blinks, wherein characteristics of each eye blink of the plurality of eye blinks differ from a successive eye blink of the plurality of eye blinks in at least one of blink speed, blink duration, interval to next eye blink, or which one or both of the left eye blink or right eye blink.
